(19) United States
(12) Patent Application Publication
(10) Pub. No.: US 2010/0159382 A1
(43) Pub. Date: Jun. 24, 2010

(54) ELECTROPHOTOGRAPHIC DEVELOPMENT CARRIER, TWO-COMPONENT DEVELOPER AND IMAGE-FORMING METHOD USING THE TWO-COMPONENT DEVELOPER

(75) Inventors: Juun Horie, Tokyo (JP); Takeshi Yamamoto, Yokohama-shi (JP); Manami Haraguchi, Yokohama-shi (JP); Kenta Kubo, Kamakura-shi (JP); Tomoaki Miyazawa, Tokyo (JP); Hirokazu Usami, Kawasaki-shi (JP); Yoshinobu Baba, Yokohama-shi (JP); Koh Ishigami, Mishima-shi (JP); Kazuo Uchida, Fuchu-shi (JP); Katsuhiro Watanabe, Wako-shi (JP); Jumpei Shirono, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/632,563

(22) Filed: Dec. 7, 2009

(30) Foreign Application Priority Data
Dec. 22, 2008 (JP) 2008-325069

(51) Int. Cl. G03G 9/107; G03G 9/00; G03G 13/06

(52) U.S. Cl. 430/111.32; 430/105; 430/97

(57) ABSTRACT

A carrier has an impedance Z having a frequency dependence, obtained by alternating current impedance measurement. When the frequency dependence is fitted by a fitting function, parameter α lies in a range of 0.70 to 0.90 in an electric field of 10³ V/cm.

### BACKGROUND OF THE INVENTION

1. Field of the Invention

The present invention relates to an electrophotographic development carrier, a two-component developer containing the electrophotographic development carrier and a toner, and an image-forming method using the two-component developer.

2. Description of the Related Art

In a known image-forming apparatus, such as a copy machine or a printer, including a two-component development system, an electrostatic latent image is formed through charging and exposure on an image bearing member having a photosensitive layer made of a photoconductor, such as an OPC (organic photoconductive) photosensitive member or an amorphous silicon photosensitive member, at the surface thereof. The electrostatic latent image is subsequently developed with a toner contained in a two-component developer transported to a developing region by a developing unit, thereby forming a toner image on the surface of the photosensitive member. The toner imager on the photosensitive layer is transferred to a transfer material directly or with an intermediate transfer member therebetween. Subsequently, the toner image is fixed to the transfer material by heating or pressure, and thus a recorded image is produced.

The two-component developer contains at least a toner and an electrophotographic development carrier (hereinafter referred to as carrier). The toner is stirred together with the carrier in the developing container, and is thus charged to a predetermined level by frictional electrification. At this time, the carrier is charged to an opposite polarity to the toner. Thus, the toner is electrostatically coupled with the carrier. When the developer is held to a developing sleeve including a magnetic member and transported as a magnetic brush to the developing region where the photosensitive member (layer) and the developing sleeve oppose each other, the toner is removed from the carrier by an electric field produced by a developing bias voltage applied to the developing sleeve and the potential of the electrostatic latent image on the photosensitive member, and thus develops the electrostatic latent image.

At this time, the effective developing electric field received by the toner in the developing region is distorted by various factors, such as the charge and electrical properties of the carrier and the charge of other toner particles. In particular, the magnetic brush formed of the carrier considerably affects the electric field. Accordingly, the quality (including image density, fog, carrier adhesion, graininess and gradation) of the image finally output depends largely on the electrical properties of the carrier. For example, the density in a high-density portion of an image is largely varied depending on the electric resistance of the carrier even if the image is developed under the same conditions. This is because the electric resistance of the carrier has a strong correlation with the developability. The developability mentioned herein refers to the ability to fill the latent image potential with the charge of a toner (to charge the latent image). In order to produce a toner image that can faithfully reproduce the electrostatic latent image, the carrier is to have a superior developability.

Even if the potential ΔVt to which a toner can charge (the charging potential of the toner) does not come to the development contrast Vcon, that is, even if the latent image is not fully charged (in an uncharged state), a desired image density can be achieved by increasing the development contrast Vcon to increasing the amount of toner used for development (amount of toner deposited on the photosensitive member).

However, if such an uncharged state occurs, the following image failure may occur.

For example, in a case where a high-density solid image (image having a maximum density) is continuously output subsequent to a low-density half-tone image, if the toner does not fill a potential required for high-density portion in the developing portion (development nip), a overhang electric field from the low-density portion to the high-density portion remains at the boundary between the two images. The overhang electric field acts so as to transfer the toner on the low-density side at the boundary to the high-density side. Accordingly, the image density on the low-density side is reduced at the boundary from the low-density portion to the high-density portion, and, thus an image failure occurs. On the high-density side, the toner particles are easily collected to the edge by the difference in electric field intensity between the edge and the middle. Consequently, a difference in image density is liable to occur between the edge and the middle of the resulting image.

In order to produce an image having a sufficient density while preventing image failure resulting from an uncharged state, the developability is to be enhanced so that the charging potential ΔVt of the toner to be deposited on the photosensitive member for development can be increased to the level of the development contrast Vcon as much as possible.

On the other hand, an uncharged state becomes liable to occur more than ever, under circumstances where electrophotography uses high printing speed close to that provided by printers and higher image quality. This is because the time for which the latent image passes through the developing region is reduced due to the increase of the printing speed and the toner is thus not sufficiently supplied to the latent image. In addition, the charge of the toner is increased to enhance the image quality, which can be evaluated in terms of graininess, fog, gradation, and so forth. Consequently, the electrostatic adhesion between the toner and the carrier is increased, and thus the development with the toner becomes difficult.

Approaches have been made to enhance the developability by controlling the resistance of the carrier. For example, by reducing the resistance of the carrier, the developability can be enhanced. Japanese Patent Publication No. 07-120086 discloses that a desired high density can be ensured in a high-density image portion by controlling the type and amount of the resin coating iron core particles so that the resistance of the carrier can be broken down by applying a high electric field. Japanese Patent Laid-Open No. 2000-10350 discloses that the carrier has a resistance in the range of 10 to 10⁸Ω·cm in an electric field of 10⁴ V/cm because a carrier having a resistance of 10⁸Ω·cm or more in that electric field cannot provide a sufficient image density.

The reason why the developability is enhanced by reducing the resistance of the carrier as described above is probably that the electrostatic adhesion between the toner and the carrier is reduced by rapidly releasing the charge of the carrier having an opposite polarity to that of the toner to the developing sleeve by applying a developing bias, and that the intensity of the electric field that the toner actually receives can thus be increased.

However, if only the resistance of the carrier is reduced, not only the charge of the carrier passes to the developing sleeve side, but also a charge having the same polarity as the charge applied to the toner from the developing sleeve is injected when a developing bias has been applied to the developing sleeve. The carrier is thus deposited on the high-density portion by an electric field produced by the developing bias and the latent image potential of the high-density portion, and white spots may appear in the high-density portion of the output image. If the resistance of the carrier is low and an electric charge is injected to the latent image potential on the photosensitive member from the developing sleeve through the magnetic brush of the carrier (hereinafter this phenomenon is referred to as “development charge injection”), the electrostatic latent image is deformed, so that the quality of the resulting image is disadvantageously degraded. For example, the image becomes grainy, or gradation failure occurs in a low-density portion with a shallow latent image potential.

Hence, in order to produce a high-quality image having low graininess and good gradation while the resistance of the carrier is controlled to ensure a desired image density, the electric resistance is to be controlled in a narrow latitude in which both high developability and prevention of development charge injection can be achieved.

The resistance of the carrier is generally controlled as below. For example, low-resistance ferrite particles may be used as the core particles of the carrier, and the thickness of the resin coating covering the core particles or the degree of the core exposed at the surfaces of the carrier can be controlled to control the resistance of the carrier. Alternatively, carbon black or electroconductive particles may be dispersed in the coating resin to control the resistance of the carrier.

Unfortunately, if the electric resistance of the carrier is controlled only by controlling the amount of the coating resin, it becomes difficult to maintain the initial electric resistance of the carrier even though the electric resistance can be controlled within an optimal range in which both the improvement of developability and the reduction of development charge injection can be achieved. The resin coating becomes liable to separate through a long-term use due to stresses applied by stirring the developer and by a control section controlling the amount of developer to be transported.

The approach of dispersing carbon black or electroconductive particles in the coating resin to control the electric resistance of the carrier may have some issues. For example, the resistance may be varied due to unstable dispersibility, or the electrification ability may be degraded.

Thus, the known approaches for controlling the resistance of the carrier do not fully achieve producing a high-quality image not affected by development charge injection while a sufficient image density is ensured, in terms of stably forming such high quality images through a long-term use.

Japanese Patent Laid-Open No. 2007-57943 proposes a resin-filled ferrite carrier including porous ferrite core particles whose pores are filled with a resin. This document discloses that since a three-dimensional structure including alternately disposed resin layers and ferrite layers has a function like a capacitor, the carrier exhibits superior electrification ability and superior stability.

If a structure of ferrite layer/resin layer/ferrite layer has a function as a single capacitor, a multilayer structure formed by repeating this structure can be a string of identical capacitors connected in series. In order for a set of capacitors to have a higher capacitance than a single capacitor, however, the capacitors are to be connected in parallel. Hence, it is difficult to consider that the function as a capacitor of the resin-filled ferrite carrier is enhanced, even though the carrier has the structure in which resin layers and ferrite layers are alternately disposed. Also, a plurality of three-dimensional structures of the carrier do not solely have the effect of enhancing the developability to ensure a sufficient image density. Hence, the carrier proposed in the above-cited Japanese Patent Laid-Open No. 2007-57943, including porous ferrite particles as core particles cannot necessarily solve the above-described issues.

Japanese Patent Laid-Open No. 2006-337579 also proposes a resin-filled ferrite carrier including porous ferrite core particles whose pores are filled with a resin. This document discloses that the deterioration of a developer can be prevented by controlling the porosity and the continuous porosity in specific ranges so as to reduce the absolute specific gravity of the carrier. According to this document, a sufficient image density can thus be ensured, and high-quality images can be stably produced over the long term. However, the developability of the carrier mainly comes from the conduction characteristics of the interior of the carrier. For the developability, particularly of the resin-filled ferrite carrier, the continuity of the ferrite component in the carrier is important. Therefore, the carrier produced by the process disclosed in the above Japanese Patent Laid-Open No. 2006-337579 is insufficient in terms of enhancing the developability to ensure a sufficient image density.

### SUMMARY OF THE INVENTION

According to an aspect of the present invention, a carrier is provided. The carrier has an impedance Z obtained by alternating current impedance measurement, and the impedance Z has a frequency dependence. When the frequency dependence is fitted by a fitting function expressed by formula (1), parameter α lies in a range of 0.70 to 0.90 in an electric field of 10³ V/cm:

$$Z ( ω ) = Re [ Z ( ω ) ] + i Im [ Z ( ω ) ] = Rs + \frac{R}{1 + {RT ( i ω )}^{α}} \qquad ( 1 )$$

where i represents an imaginary unit;

ω represents an angular frequency for alternating current impedance measurement;

Rs and R represent real number parameters with the dimension of resistance;

α represents a dimensionless real number parameter of 0 to 1; and

T represents a real number parameter and (RT)^{1/α} has the dimension of time.

Further features of the present invention will become apparent from the following description of exemplary embodiments with reference to the attached drawings.

### BRIEF DESCRIPTION OF THE DRAWINGS

FIG. 1 is a schematic representation of an image-forming method according to an embodiment of the present invention.

FIG. 2 is a schematic diagram of electrostatic latent image potential and developing bias potential.

FIG. 3 is a schematic representation of an alternating current impedance measuring method.

FIG. 4 is a fitting circuit diagram for fitting the Cole-Cole plot obtained by measuring impedance.

FIG. 5 is a Cole-Cole plot obtained by measuring the impedance of the circuit shown in FIG. 4.

FIG. 6 is a Cole-Cole plot obtained by measuring the impedance of a carrier or core particles.

FIG. 7 is a schematic representation of a configuration for measuring a dynamic resistance.

FIG. 8 is a schematic view of a Faraday cylinder for measuring the amount M/S of toner deposited on the photosensitive member and the average charge quantity Q/M of the toner.

FIG. 9 is a graph of a γ curve for obtaining an effective gradation.

FIG. 10 is a Cole-Cole plot obtained by measuring the impedances of circuits 2 and 9.

FIG. 11 is a plot showing the applied electric field (Esample) dependence of the α value of carriers 2 and 9.

FIG. 12 is a plot showing the applied electric field (Esample) dependence of the α value of magnetic cores 1 and 5.

FIG. 13 is a plot showing the applied electric field (Esd) dependence of the current density J(A/cm²) of carriers 2 and 9.

### DESCRIPTION OF THE EMBODIMENTS

The time constant of the electrical conduction properties of a carrier can have a range by varying the state of continuity of electroconductive portions in each carrier particle. More specifically, when a core particle has interfaces therein having a wide range of time constant from an extremely low time constant to an extremely high time constant, the electrical conduction is locally reduced inside the core particle by applying an external electric field, and thus a large polarization is formed. The present inventors has found that the degree of spread of the time constant distribution has a strong correlation with the developability, and that by broadening the time constant distribution, the developability of the carrier can be enhanced without excessively reducing the electric resistance of the carrier.

The spread of the time constant distribution appears in the frequency dependence of complex impedance obtained by measuring alternating current impedance. It is empirically known that when the time constant has a specific distribution, the frequency dependence of complex impedance can be expressed by Cole-Cole equation shown in equation (2). In equation (2), α represents a parameter corresponding to the spread of time constant distribution, and it is known that as the spread of time constant distribution is increased, α is reduced to less than 1. This is described in “Impedance Spectroscopy” (published by Wiley Interscience) written by Evgenij Barsoukov and J. Ross Macdonald.

$$Z ( ω ) = Re [ Z ( ω ) ] + i Im [ Z ( ω ) ] = \frac{R}{1 + {RT ( i ω )}^{α}} \qquad ( 2 )$$

In the equation, i represents the imaginary unit, ω represents the angular frequency for alternating current impedance measurement, R represents a real number parameter with the dimension of resistance, α represents a dimensionless real number parameter of 0 to 1, and T represents a real number parameter and (RT)^{1/α} has the dimension of time.

By measuring the alternating current impedance of the carrier to obtain the frequency dependence of complex impedance, and further obtaining the value of α by fitting the above Cole-Cole equation, the degree of time constant distribution of the carrier can be known.

Thus, the present inventors have found that when a lies in the range of 0.70 to 0.90, the continuity of electroconductive portions inside the carrier particle can be appropriately varied to enhance the developability without extremely reducing the electric resistance of the carrier.

The carrier having such electrical conduction properties can be a carrier containing porous ferrite particles as core particles. In a porous ferrite core, the time constant distribution can be broadened by giving variations to the state of connections among crystal grains grown by firing the ferrite particles. The state of connections among crystal grains refers to a state of the interfaces between crystal grains, including various factors, such as the area of the interfaces, the electric resistance of precipitate produced at the interfaces by firing, and the distribution of compositions around the interfaces. In addition, by controlling the amount of resin filling the pores of the core particles and the amount of resin coating the core particles after filling with resin, such an electric resistance as can prevent the development charge injection can be imparted, and a large polarization can be formed inside the carrier in an electric field. Hence, the apparent dielectric constant can be increased while the resistance of the carrier is kept relatively high.

If a dielectric material is placed in an electric field, the external electric field around the dielectric material is generally distorted due to the polarization formed inside the dielectric material. In development using a two-component developer as well, the actual electric field around a carrier to which a developing bias has been applied is more largely distorted when the carrier has a high apparent dielectric constant than when it has a low dielectric constant. Accordingly, the actual electric field the toner attached to the carrier receives is intensified. Thus, the toner becomes likely to fly from the carrier.

Accordingly, as described above, by giving variations to the state of connections among crystal grains of porous ferrite core particles grown by firing ferrite particles, the resulting carrier can exhibit high developability without extremely reducing the electric resistance.

An image-forming method using a two-component developer containing a carrier having the above-described electrical properties can reduce the development charge injection caused by reducing the resistance of the carrier while ensuring a sufficient image density, and, can thus produce high-quality image.

Specific embodiments of the invention will now be described.

An electrophotographic development carrier according to an embodiment of the present invention includes a core. The core can be a particle of a porous ferrite. The porous ferrite comprises a sintered material expressed by the following compositional formula:

(M1₂O)u(M2O)v(M3₂O₃)w(M4O₂)x(M5₂O₅)y(Fe₂O₃)z

In the formula, M1 represents a monovalent metal; M2, a divalent metal; M3, a trivalent metal; M4, a tetravalent metal; and M5, a pentavalent metal. When u+v+w+x+y+z=1.0, u, v, w, x and y each satisfy the relationship 0≦(u, v, w, x, y) 0.8 and z satisfies 0.2<z<1.0.

Also, M1 to M5 in the formula are metallic elements selected from the group consisting of Li, Fe, Zn, Ni, Mn, Mg, Co, Cu, Ba, Sr, Ca, Si, V, Bi, In, Ta, Zr, B, Mo, Na, Sn, Ti, Cr, Al, Sc, Y, La, Ce, Pr, Nd, Sm, Eu, Gd, Tb, Dy, Ho, Er, Tm, Yb, and Lu.

Examples of the porous ferrite include magnetic Li ferrite such as (Li₂O)a(Fe₂O₃)b (0.0<a<0.4, 0.6≦b<1.0, a+b=1), Mn ferrite such as (MnO)a(Fe₂O₃)b (0.0<a<0.5, 0.5≦b<1.0, a+b=1), Mn—Mg ferrite such as (MnO)a(MgO)_{b}(Fe₂O₃)c (0.0<a<0.5, 0.0<b<0.5, 0.5≦c<1.0, a+b+c=1), Mn—Mg—Sr ferrite such as (MnO)a(MgO)_{b}(SrO)c(Fe₂O₃)d (0.0<a<0.5, 0.0<b<0.5, 0.0<c<0.5, 0.5≦d<1.0, a+b+c+d=1), and Cu—Zn ferrite such as (CuO)a(ZnO)_{b}(Fe₂O₃)c (0.0<a<0.5, 0.0<b<0.5, 0.5≦c<1.0, a+b+c=1). The above compositional formulas of the ferrite are represented by principal elements, and may contain other trace metals.

In addition, in order to give variations to the state of connections among crystal grains inside the porous ferrite core, silica fine particles or the like may be added in a granulation step.

From the viewpoint of easily controlling the crystal growth rate, Mn ferrites containing Mn element are suitable, such as Mn—Mg ferrite and Mn—Mg—Sr ferrite.

The process for preparing the porous ferrite core will be described below.

### Step 1 (Weighing and Mixing):

Raw materials of ferrite are weighed out and mixed.

The raw materials of ferrite include: Li, Fe, Zn, Ni, Mn, Mg, Co, Cu, Ba, Sr, Y, Ca, Si, V, Bi, In, Ta, Zr, B, Mo, Na, Sn, Ti, Cr, Al, and particles, oxides, hydroxides, oxalates and carbonates of rare earth metals. The raw materials are mixed in, for example, a ball mill, a planetary mill, a jet mill or a vibrating mill. A ball mill is particularly suitable from the viewpoint of sufficiently mixing the materials.

Specifically, weighed ferrite raw materials are placed in a ball mill with balls and pulverized and mixed for 0.1 to 20.0 hours.

### Step 2 (Calcining):

The mixture of the pulverized ferrite raw materials is calcined into ferrite at a temperature in the range of 700 to 1000° C. for 0.5 to 5.0 hours in the atmosphere. The calcination is performed in a furnace, such as a burner furnace, a rotary furnace or an electric furnace.

### Step 3 (Pulverization):

The calcined ferrite prepared in Step 2 is pulverized by a pulverizer.

Any pulverizer may be used without particular limitation, as long as the material can be pulverized into a desired particle size. Examples of the pulverizer include a crusher, a hammer mill, a ball mill, a bead mill, a planetary mill and a jet mill.

The calcined ferrite can be pulverized to a volume-based median particle size (D50) of 0.5 to 5.0 μm, or to a volume-based 90% particle size (D90) of 2.0 to 7.0 μm. In addition, the size distribution expressed by D90/D50 of the pulverized calcined ferrite can be in the range of 1.5 to 10.0. By preparing particles having sizes in a wider range to some extent, the state of connection among crystal grains in each carrier particle can have variations.

In order to pulverize the calcined ferrite to such particle sizes, the material of, for example, ball or beads for a ball mill or bead mill and the operation time can be controlled. In order to reduce the particle size of the calcined ferrite, for example, balls having a high specific gravity can be used, or the pulverization time can be increased. In order to broaden the particle size distribution of the calcined ferrite, pulverization can be performed for a short time with balls having a high specific gravity. A plurality of types of calcined ferrite having different particle sizes may be used to broaden the size distribution.

The material of the balls or beads is not particularly limited as long as a desired particle size and distribution can be obtained. Examples of the ball or bead material include glasses such as soda glass (specific gravity: 2.5 g/cm³), sodium-free glass (specific gravity: 2.6 g/cm³) and high density glass (specific gravity: 2.7 g/cm³), quartz (specific gravity: 2.2 g/cm³), titania (specific gravity: 3.9 g/cm³), silicon nitride (specific gravity: 3.2 g/cm³), alumina (specific gravity: 3.6 g/cm³), zirconia (specific gravity: 6.0 g/cm³), steel (specific gravity: 7.9 g/cm³), and stainless steel (specific gravity: 8.0 g/cm³). Among those preferred are alumina, zirconia and stainless steel. These materials are superior in wear resistance.

The size of the balls or beads is not particularly limited as long as a desired particle size and distribution can be obtained. If a ball mill is used, for example, the balls may have a diameter in the range of 5 to 60 mm. If a bead mill is used, the beads may have a diameter in the range of 0.03 to 5 mm.

A wet type ball mill or bead mill prevents the pulverized material from being blown up, and accordingly can more efficiently pulverize the material than a dry type. Thus, a wet type pulverizer is to be used.

### Step 4 (Granulation):

A ferrite slurry is prepared by adding water and a binder to the pulverized calcined ferrite. A pore size adjuster, silica particles and other additives may also be added.

A foaming agent or resin particles may be used as the pore size adjuster. Exemplary foaming agents include sodium hydrogencarbonate, potassium hydrogencarbonate, lithium hydrogencarbonate, ammonium hydrogencarbonate, sodium carbonate, potassium carbonate, lithium carbonate, and ammonium carbonate. Exemplary resin particles include particles of polyester; polystyrene; styrene copolymers, such as styrene-vinyl toluene copolymer, styrene-vinyl naphthalene copolymer, styrene-acrylate copolymer, styrene-methacrylate copolymer, styrene-α-chloromethyl methacrylate copolymer, styrene-acrylonitrile copolymer, styrene-vinyl methyl ketone copolymer, styrene-butadiene copolymer, styrene-isoprene copolymer, and styrene-acrylonitrile-indene copolymer; polyvinyl chloride; phenol resin; modified phenol resin; maleic resin; acrylic resin; methacrylic resin; polyvinyl acetate; silicone resin; polyester resins having as the structural unit a monomer selected from among aliphatic polyhydric alcohols, aliphatic dicarboxylic acids, aromatic dicarboxylic acids, and aromatic dialcohols and diphenols; polyurethane resin; polyamide resin; polyvinyl butyral, terpene resin; coumarone-indene resin; petroleum resin; and hybrid resin including a polyester unit and a vinyl polymer unit.

The silica particles can have a weight-average particle size in the range of 1 to 10 μm, and preferable in the range of 2 to 5 μm. The silica particles can be added in a ratio of 5 to 45 parts by mass to 100 parts by mass of ferrite particles. By adding silica particles in such a proportion, the silica particle content in the resulting magnetic core can be controlled in the range of 4.0% to 40.0% by mass. By using silica particles exhibiting a broad particle size distribution, the state of connection among crystal grains inside the porous ferrite core can have variations. The silica particles can have any shape, and preferable has a spherical form. Spherical silica particles can be uniformly dispersed in the granulation step and can appropriately suppress the crystal growth of ferrite during sintering.

The binder may be, for example, a water-soluble polyvinyl alcohol.

If the pulverization in Step 3 is performed by a wet process, a binder, and if suitable a pore size adjuster and silica particles, be added in view of the water contained in the slurry.

The resulting ferrite slurry is dried and granulated using a spray dryer in an atmosphere heated to a temperature of 70 to 200° C.

The spray dryer is not particularly limited, and any type can be used as long as porous ferrite core particles having a desire particle size can be obtained.

In order to give variations to the state of connections among crystal grains in each particle of an electrophotographic development carrier, different types of ferrite slurry having different compositions can be mixed and granulated.

### Step 5 (Firing):

Then, the granulated ferrite is fired at a temperature of 800 to 1400° C. for 1 to 24 hours. In one embodiment, the firing temperature is 1000 to 1200° C. The firing temperature and the firing time are to be controlled to the above ranges so that the area ratio of the ferrite domain to the entire section of the electrophotographic development carrier can be in the range of 50% to 90%. Also, the heating rate profile and the cooling rate profile may be controlled. Thus, the variation of the state of connections can be controlled.

By raising the firing temperature or by extending the firing time, the firing of the porous ferrite core particles can be promoted. Consequently, the area of the ferrite domain is increased.

### Step 6 (Screening):

After pulverizing the fired particles, the particles may be subjected to screening with a classifier or a sieve to remove excessively large or small particles.

The α value of the porous ferrite core particles can be in the range of 0.50 to 0.80 in an electric field of 10² V/cm. The α value of the electrophotographic development carrier can be further controlled in the range of 0.70 to 0.90 by filling the pores of the porous ferrite core particles with a resin, or by coating the surfaces of the core particles with a resin.

In order that the electrophotographic development carrier has a desired α value and a desired resistance, the pores of the resulting porous ferrite core particles are to be filled with a resin. In addition, the surfaces of the resin-filled core particles may be coated with a resin to control the properties of the electrophotographic development carrier.

The resin can fill the pores such that the area ratio of the ferrite domain becomes 50% to 90% relative to the section of the electrophotographic development carrier observed in a reflection electron image taken by scanning electron microscopy. By controlling the area ratio of the ferrite domain in such a range while the α value is controlled in the above-described specific range, the conducting paths in the ferrite domain inside the carrier particle are appropriately restricted to impart particularly superior electrical conduction properties. The control of the area ratio of the ferrite domain in the above range also allows the dynamic resistivity ρ to be easily controlled in an appropriate range.

The method for filling the pores of the porous ferrite core particles is not particularly limited. For example, pores of the porous ferrite core particles may be penetrated by a resin solution.

The resin solution contains 1% to 50% by mass of resin solid, and preferably 1% to 30% by mass of solid. If the solid content in the resin solution is 50% by mass or less, the viscosity is not increased, and, accordingly, the resin solution can easily and uniformly permeate the pores of the porous ferrite core particles. In addition, if the solid content is 1% by mass or more, the volatilization rate of the solvent is not excessively reduced, and the resin can fill the pores uniformly. The resulting electrophotographic development carrier filled with the resin can have a desired α value at the surface.

The resin filling the pores of the porous ferrite core particles is not particularly limited, and may be a thermoplastic resin or a thermosetting resin. In one embodiment, the resin has high affinity for the porous ferrite core particles. A high-affinity resin can fill the pores of the porous ferrite core particles and easily coat the surfaces of the porous ferrite core particles, simultaneously.

Examples of the thermoplastic resin include polystyrene, polymethyl methacrylate, styrene-acrylic resin, styrene-butadiene copolymer, ethylene-vinyl acetate copolymer, polyvinyl chloride, polyvinyl acetate, polyvinylidene fluoride resin, fluorocarbon resin, perfluorocarbon resin, polyvinyl pyrrolidone, petroleum resin, novolak resin, saturated alkyl polyester resin, polyethylene terephthalate, polybutylene terephthalate, polyacrylate, polyamide resin, polyacetal resin, polycarbonate resin, polyethersulfone resin, polysulfone resin, polyphenylene sulfide resin, and polyether ketone resin.

Examples of the thermosetting resin include phenol resin, modified phenol resin, maleic resin, alkyd resin, epoxy resin, unsaturated polyestermaleic anhydride produced by polycondensation of terephthalic acid and a polyhydric alcohol, urea resin, melamine resin, urea-melamine resin, xylene resin, toluene resin, guanamine resin, melamine-guanamine resin, acetoguanamine resin, Glyptal resin, furan resin, silicone resin, modified silicone resin, polyimide, polyamide imide resin, polyether imide resin, and polyurethane resin.

Modified forms of these resins may be used. Among those preferred are fluorine-containing resins, such as polyvinylidene fluoride resin, fluorocarbon resin, perfluorocarbon resin and solvent-soluble perfluorocarbon resin, and acrylic modified silicone resin and silicone resin. These resins have high affinity for porous ferrite core particles.

Silicone resin is particularly suitable. The silicone resin can be selected from among known products.

Exemplary silicone resin products include straight silicone resins, such as KR271, KR255 and KR152 (produced by Shin-Etsu Chemical), and SR2400, SR2405, SR2410 and SR2411 (produced by Dow Corning Toray); and modified silicone resins, such as KR206 (alkyd-modified), KR5208 (acrylic-modified), ES1001N (epoxy-modified) and KR305 (urethane-modified)(produced by Shin-Etsu Chemical), and SR2115 (epoxy-modified) and SR2110 (alkyd-modified) (produced by Dow Corning Toray).

A silane coupling agent may be added as a charge control agent to the silicone resin. If added, 1 to 50 parts by mass of silane coupling agent is added to 100 parts by mass of solid content of the resin.

Examples of the silane coupling agent include γ-aminopropyltrimethoxysilane, γ-aminopropylmethoxydiethoxysilane, γ-aminopropyltriethoxysilane, N-β-(aminoethyl)-γ-aminopropyltrimethoxysilane, N-β-(aminoethyl)-γ-aminopropylmethyldimethoxysilane, N-phenyl-γ-aminopropyltrimethoxysilane, ethylenediamine, ethylenetriamine, styrene-dimethylaminoethyl acrylate copolymer, styrene-dimethylaminoethyl methacrylate copolymer, isopropyltri(N-aminoethyl) titanate, hexamethyldisilazane, methyltrimethoxysilane, butyltrimethoxysilane, isobutyltrimethoxysilane, hexyltrimethoxysilane, octyltrimethoxysilane, decyltrimethoxysilane, dodecyltrimethoxysilane, phenyltrimethoxysilane, o-methylphenyltrimethoxysilane, and p-methylphenyltrimethoxysilane.

For filling the pores of the porous ferrite core particles with a resin, a resin solution prepared by dissolving the resin in a solvent may be poured into the pores. Any solvent may be used as long as it can dissolve the resin. If the resin is soluble in organic solvents, an organic solvent is used, such as toluene, xylene, Cellosolve butyl acetate, methyl ethyl ketone, methyl isobutyl ketone, or methanol. For a water-soluble resin or an emulsion resin, water can be used as the solvent. For filling the pores of the porous ferrite core particles with a resin, alternatively, the porous ferrite core particles may be impregnated with a resin solution by immersion, spraying, brush coating, fluidized bed coating, or the like, and then the solvent is evaporated.

The electrophotographic development carrier of an embodiment of the present invention may be further coated with a resin from the viewpoint of controlling the releasability, the resistance to contamination and the electrification ability as well as ensuring a desired α value and resistance. The surface of the porous ferrite core particles may be further coated with a resin after the pores of the core particles are filled with a resin.

The coating resin may be a thermoplastic resin or a thermosetting resin, and may be the same as the resin for filling the pores of the porous ferrite core particles.

Silicone resins or modified silicone resins are particularly suitable. Examples of such resins are the same as above.

The above-listed resins may be used singly or in combination. A curing agent or the like may be added to a thermoplastic resin. It is beneficial to use a resin that can easily be removed.

The coating resin may contain an electroconductive particles or charge-controllable particles or material.

Exemplary electroconductive particles include particles of carbon black, magnetite, graphite, zinc oxide, and tin oxide.

The content of the electroconductive particles in the coating of the core is 2 to 80 parts by mass relative to 100 parts by mass of the coating resin.

Exemplary charge-controllable particles include particles of organic metal complexes, organic metal salts, chelate compounds, monoazo metal complexes, acetyl acetone metal complexes, hydroxycarboxylic acid metal complexes, polycarboxylic acid metal complexes, polyol metal complexes, polymethyl methacrylate resin, polystyrene resin, melamine resin, phenol resin, nylon resin, silica, titanium oxide, and alumina.

The content of the charge-controllable particles in the coating of the core is 2 to 80 parts by mass relative to 100 parts by mass of the coating resin.

The charge-controllable material may be selected from among the silane coupling agents listed above that can be added to the silicone resin.

The content of the charge-controllable material in the coating of the core is 2 to 80 parts by mass relative to 100 parts by mass of the coating resin.

The coating covering the surfaces of the porous ferrite core particles whose pores are filled with a resin may be formed by immersion, spraying, brush coating, fluidized bed coating or the like. Among those methods, preferred is immersion from the viewpoint of controlling the α value while the resistance of the carrier is kept in a desired range.

From the viewpoint of setting the α value in a desired range, the amount of coating can be in the range of 0.1 to 5.0 parts by mass relative to 100 parts by mass of porous ferrite core particles.

The coating formed over the surfaces of the carrier core particles tends to increase the α value of the carrier from that of the carrier particles. This is because the carrier core particles fully covered with the coating cannot easily exhibit the effect produced by giving variations to the state of connections among crystal grains inside the carrier core. Accordingly, if the carrier core particles are coated, the thickness or the amount of coating is to be carefully controlled. In order that the carrier has a desire α value, the carrier core particles can be coated so as to be partially exposed.

The carrier according to an embodiment of the present invention can have a dynamic electric resistivity ρ (hereinafter referred to as resistivity ρ) of 1.0×10⁶ to 1.0×10⁸Ω·cm in a magnetic brush state in an electric field of 10⁴ V/cm. Such a carrier is not affected much by changes in electric resistance of the carrier in a long-term use for printing, or the variation of the mechanical distance between the developing sleeve and the photosensitive drum.

The electrophotographic development carrier of an embodiment of the present invention can have a volume-based D50 of 20.0 to 60.0 μm. Carriers having a particle size in such a specific range are beneficial in view of the ability to frictionally electrify the toner, carrier adhesion, and the prevention of fog. The D50 of the electrophotographic development carrier can be controlled by classification using wind force or a sieve.

The electrophotographic development carrier of an embodiment of the present invention is combined with a toner and used as a two-component developer.

The ratio of the toner to the electrophotographic development carrier in the two-component developer can be 2 to 15 parts by mass to 100 parts by mass, preferably 4 to 10 parts by mass to 100 parts by mass. Such a ratio can achieve a high image density and reduce the scattering of the toner.

The two-component developer containing the electrophotographic development carrier and a toner can be used for a two-component development method in which a replenishing developer containing a toner and a electrophotographic development carrier is supplied to a developing unit and at least an excess of the electrophotographic development carrier is discharged from the developing unit, and is thus used as a replenishing developer.

For use as the replenishing developer, the ratio of the toner to the electrophotographic development carrier can be 2 to 50 parts by mass to 1 part by mass, from the viewpoint of enhancing the durability of the developer.

The toner used in the two-component developer will now be described. A preferred toner is as below.

The toner may comprise toner particles containing a resin having a polyester unit as a main constituent and a coloring agent. The “polyester unit” refers to a portion derived from polyester, and the “resin having a polyester unit as a main constituent” refers to a resin including repeating units many (i.e., 50% or more) of which have ester bonds. This will be further described in detail below.

The polyester unit can be synthesized using a polyhydric alcohol and a carboxylic acid. Among polyhydric alcohols, dihydric alcohols include bisphenol A alkylene oxide adducts such as polyoxypropylene(2.2)-2,2-bis(4-hydroxyphenyl)propane, polyoxy propylene(3.3)-2,2-bis(4-hydroxyphenyl)propane, polyoxyethylene(2.0)-2,2-bis(4-hydroxyphenyl)propane, polyoxypropylene(2.0)-polyoxyethylene(2.0)-2,2-bis(4-hydroxyphenyl)propane and polyoxypropylene(6)-2,2-bis(4-hydroxyphenyl)propane, ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, bisphenol A, and hydrogenated bisphenol A.

Among polyhydric alcohols, trihydric or more polyhydric alcohols include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

Examples of the carboxylic acid used for synthesizing the polyester unit include divalent carboxylic acids and trivalent or more polyvalent carboxylic acids.

Exemplary divalent carboxylic acids include aromatic dicarboxylic acids, such as phthalic acid, isophthalic acid and terephthalic acid, and their anhydrides; alkyldicarboxylic acids, such as succinic acid, adipic acid, sebacic acid and azelaic acid, and their anhydrides; succinic acids having an alkyl substituent having a carbon number in the range of 6 to 12 and their anhydrides; unsaturated dicarboxylic acids, such as fumaric acid, maleic acid and citraconic acid, and their anhydrides. Exemplary trivalent or more polyvalent carboxylic acids include 1,2,4-benzenetricarboxylic acid, 1,2,5-benzenetricarboxylic acid, 1,2,4-naphthalenetricarboxylic acid, 2,5,7-naphthalenetricarboxylic acid, 1,2,4,5-benzenetetracarboxylic acid, and their acid anhydrides and esters.

A preferred resin having a polyester unit that can be contained in the toner particles may comprise a polyester resin synthesized by polycondensation of an alcohol component and a carboxylic acid component, such as a divalent or more polyvalent carboxylic acid, its anhydride or its lower alkyl ester. The alcohol component is a bisphenol derivative represented by the structure expressed by general formula (I). Examples of the carboxylic acid component include fumaric acid, maleic acid, maleic anhydride, phthalic acid, terephthalic acid, dodecenyl succinic acid, trimellitic acid, and pyromellitic acid.

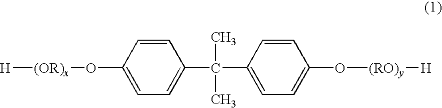

wherein R represents an ethylene group and/or a propylene, x and y are each a natural number, and the average of x+y is 2 to 10.

Other preferred resins having a polyester unit that can be contained in the toner particles include: (a) a hybrid resin in which a polyester unit and a vinyl polymer unit are chemically bonded to each other; (b) a mixture of a hybrid resin and a vinyl polymer; (c) a mixture of a polyester resin and a vinyl polymer; (d) a mixture of a hybrid resin and a polyester resin; and (e) a mixture of a polyester resin, a hybrid resin and a vinyl polymer.

The above-mentioned vinyl polymer unit refers to a portion derived from vinyl polymer. The vinyl polymer unit or vinyl polymer can be obtained by polymerizing vinyl monomers described later.

The toner may be produced by a process of melting, kneading and pulverizing, or may be a so-called chemical toner produced by suspension polymerization, emulsion polymerization, or dissolving and suspending. The toner may be subjected to spheronization treatment or surface smoothing treatment. Such a toner is superior in transfer property.

Vinyl monomers used for producing the toner particles by suspension polymerization or emulsion polymerization include styrene monomers, acrylic monomers, methacrylic monomers, unsaturated monoolefin monomers, vinyl ester monomers, vinyl ether monomers, vinyl ketone monomers, N-vinyl compound monomers, and other vinyl monomers.

Exemplary styrene monomers include styrene, o-methylstyrene, m-methylstyrene, p-methylstyrene, p-methoxystyrene, p-phenylstyrene, p-chlorostyrene, 3,4-dichlorostyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, and p-n-dodecylstyrene.

Exemplary acrylic monomers include acrylic esters, such as methyl acrylate, ethyl acrylate, n-butyl acrylate, isobutyl acrylate, propyl acrylate, n-octyl acrylate, dodecyl acrylate, 2-ethylhexyl acrylate, stearyl acrylate, dimethylaminoethyl acrylate and phenyl acrylate; acrylic acid; and acrylic acid amides. Exemplary methacrylic monomers include methacrylates corresponding to the above-listed acrylates.

A polymerization initiator may be used for producing the vinyl polymer. Examples of the polymerization initiator include known azo or diazo polymerization initiators, peroxide initiators, initiators having peroxide at a side chain, persulfates, and hydrogen peroxide. Trifunctional or more polyfunctional polymerization initiators may be used.

The toner used in the two-component developer of an embodiment of the present invention may be used in an electrophotographic process adopting oilless fixation. In this instance, the toner is to contain a release agent.

Examples of the release agent include low-molecular-weight polyethylenes, low-molecular-weight polypropylenes, polyolefin copolymers, aliphatic hydrocarbon waxes such as polyolefin waxes, microcrystalline waxes, paraffin waxes and Fischer-Tropsch waxes, oxides of aliphatic hydrocarbon waxes such as polyethylene oxide waxes, block copolymers of those waxes, waxes mainly containing a fatty acid ester such as carnauba waxes, montanic acid ester waxes and behenyl behenate, and partially or fully deoxidized fatty acid esters such as deoxidized carnauba waxes. Among those, preferred are hydrocarbon waxes and paraffin waxes.

The toner used in an embodiment of the present invention can have an endothermic curve obtained by differential scanning calorimetry (DSC) having at least one endothermic peak in the range of 30 to 200° C., and the maximum peak of the endothermic peaks lies in the range of 50 to 110° C. Such a toner exhibits superior developability without increasing the adhesion to the carrier, and tends to enhance the low-temperature fixity, the durability and other toner properties.

The release agent content in the toner can be 1 to 15 parts by mass, preferably 3 to 10 parts by mass, relative to 100 parts by mass of binding resin in the toner particles. Such a release agent content leads to high releasability, and tends to exhibit superior transfer properties in oilless fixation.

The toner may contain a charge control agent. Examples of the charge control agent include organic metal complexes, metal salts, and chelate compounds. Exemplary organic metal complexes include monoazo metal complexes, acetyl acetone metal complexes, hydroxycarboxylic acid metal complexes, polycarboxylic acid metal complexes, and polyol metal complexes. Other charge control agents include carboxylic acid derivatives, such as carboxylic acid metal salts, carboxylic acid anhydrides and carboxylic acid esters, and condensation products of aromatic compounds. In addition, phenol derivatives, such as bisphenols and calixarene may be used as the charge control agent. The charge control agent contained in the toner used in an embodiment of the present invention can be a metal compound of an aromatic carboxylic acid from the viewpoint of immediate electrification of the toner.

The charge control agent content can be 0.1 to 10.0 parts by mass, preferably 0.2 to 5.0 parts by mass, relative to 100 parts by mass of binding resin. Such a charge control agent content can reduced the variation of frictional charge quantity of the toner in a wide range of environment from high temperature high humidity to low temperature low humidity.

The toner may contain a coloring agent. The coloring agent may be a known pigment or dye, or a combination of them.

The coloring agent content in the toner can be 1 to 15 parts by mass, preferably 3 to 12 parts by mass and more preferably 4 to 10 parts by mass, relative to 100 parts by mass of binding resin in the toner particles. Such a coloring agent content allows the toner to maintain the transparency and enhances the reproducibility of neutral tints represented by skin tones. In addition, the chargeability of the toner can be enhanced and low-temperature fixity is imparted to the toner.

The toner can contain inorganic particles as an external additive. Examples of the inorganic particles include titanium oxide, alumina oxide, and silica.

The inorganic particles may be subjected to hydrophobization treatment at their surfaces. For the hydrophobization treatment, a hydrophobizing agent can be used. Exemplary hydrophobizing agents include coupling agents, such as titanium coupling agents and silane coupling agents; fatty acids and their metal salts; silicone oil; and combinations of those agents.

In particular, the toner used in an embodiment of the present invention can contain hydrophobic silica particles exhibiting a number-based distribution having a maximum peak at a particle size of 30 nm or more. In one embodiment, the maximum peak in the number-based distribution of the hydrophobic silica particles lies at a particle size in the range of 30 to 200 nm.

Hydrophobic silica particles having a maximum peak at a particle size in the above range help the toner maintain developability for the long term in combination use with the carrier of an embodiment of the present invention. Consequently, the occurrence of a white spot can be prevented.

The degree of hydrophobization of the inorganic particles, which is not particularly limited, is, for example, such that the inorganic particles after hydrophobization treatment has a hydrophobization degree (methanol wettability, an index of wettability to methanol) measured by methanol titration in the range of 40% to 95%.

Specifically, the hydrophobization degree can be obtained from a methanol titration transmittance curve.

First, 70 mL of water-containing methanol containing 60% by volume of methanol and 40% by volume of water is placed in a cylindrical glass vessel of 5 cm in diameter and 1.75 mm in thickness, and was subjected to ultrasonic dispersion for 5 minutes to remove air bubbles.

Then, 0.06 g of inorganic particles accurately weighed out is added to the water-containing methanol in the glass vessel to prepare a measurement sample.

The measurement sample is set in a powder wettability tester WET-100P (manufacture by RHESCA). The measurement sample is stirred with a magnetic stirrer at a speed of 6.7 s⁻¹ (400 rpm). The stirring bar of the magnetic stirrer is a fusiform bar coated with fluorocarbon polymer and having a length of 25 mm and a maximum diameter of 8 mm.

Then, the transmittance is measured with light having a wavelength of 780 nm while methanol is dropped into the measurement sample through the above-mentioned instrument at a dropping speed of 1.3 mL/min, and a methanol titration transmittance curve is prepared. The hydrophobization degree is defined by the volume percent of methanol at a transmittance of 50% in the prepared methanol titration transmittance curve.

The inorganic particle content in the toner can be in the range of 0.1% to 5.0% by mass, preferably in the range of 0.5% to 4.0% by mass. The inorganic particles may be a mixture of a plurality of types of inorganic particles.

### Image-Forming Method

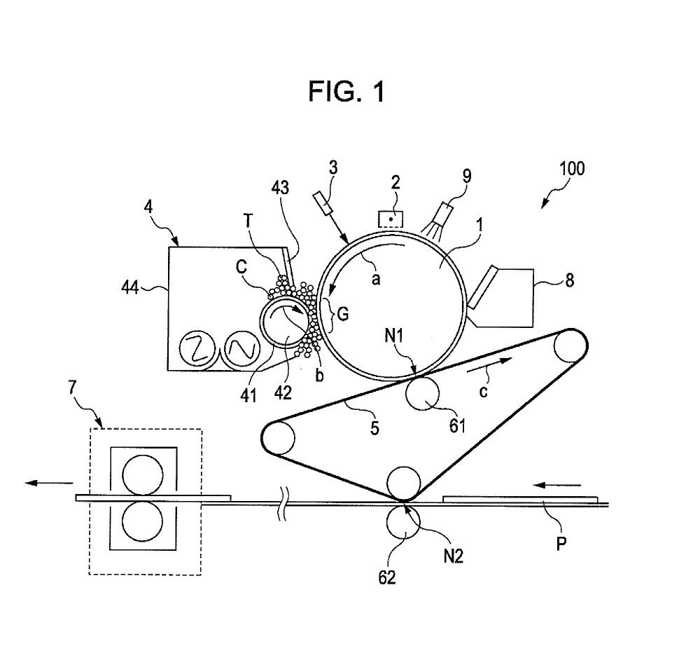

FIG. 1 is a schematic sectional view showing parts of an image forming apparatus 100 used in an embodiment of the present invention.

The image forming apparatus 100 includes a cylindrical electrophotographic photoreceptor or photosensitive member drum (hereinafter simply referred to as photosensitive member) 1 as an electrostatic latent image bearing member. A charger 2 for charging, an exposure device 3 for exposure, a developing unit 4 for development, an intermediate transfer member 5 transporting a toner image developed on the photosensitive member 1 to a secondary transfer section N2, a cleaner 8 for cleaning and a pre-exposure device 9 for pre-exposure are disposed around the photosensitive member 1. In addition, the image forming apparatus 100 includes a primary transfer roller 61 transferring the toner image on the photosensitive member 1 to the intermediate transfer member 5, a secondary transfer roller 62 transferring the toner image on the intermediate transfer member 5 to a transfer material P, and a fuser 7 fixing the toner image on the transfer material P.

The photosensitive member 1 may be a general OPC photosensitive member including at least an organic photoconductor layer or an a-Si photosensitive member including at least an amorphous silicon layer.

The photosensitive member 1 is driven for rotation at a predetermined peripheral speed. The surface of the rotating photosensitive member 1 is substantially uniformly charged by the charger 2. The exposure device 3 emits laser light according to an image signal to the position on the photosensitive member 1 opposing the exposure device 3 to form an electrostatic image corresponding to an original image.

The electrostatic image formed on the photosensitive member 1 is transported to the position opposing the developing unit 4 by the rotation (in direction a) of the photosensitive member 1, and is then developed into a toner image with a two-component developer from the developing unit 4 containing nonmagnetic toner particles (toner) T and magnetic carrier particles (carrier) C. The toner image is formed substantially of only the toner of the two-component developer.

The developing unit 4 includes a developing container (developing unit body) 44 accommodating the two-component developer. The developing container 4 has a developing sleeve 41 acting as a developer bearing member. The developing sleeve 41 is disposed in the developing container 44 and contains a magnet 42 inside for generating a magnetic field.

In the present embodiment, the developing sleeve 41 as a developer bearing member is rotated such that the surface of the developing sleeve 41 moves toward the same direction (direction b) as the surface of the photosensitive member 1 at the position (developing portion G) where the two surfaces oppose each other, at a higher speed than the photosensitive member 1. While the amount of the two-component developer is controlled by a control member 43, the developer held on the surface of the developing sleeve 41 is transported to the developing portion G where the developing sleeve 41 and the photosensitive member 1 oppose each other.

The carrier C carries the charged toner to the developing portion G. The toner T is mixed with the carrier C to be charged to a predetermined polarity and a predetermined potential level by frictional electrification. The two-component developer on the developing sleeve 41 is raised to form a magnetic brush at the developing portion G by a magnetic field generated from the magnet 42. In the present embodiment, the magnetic brush is brought into contact with the surface of the photosensitive member 1 and a predetermined developing bias is applied to the developing sleeve 41. Thus only the toner T of the two-component developer is transferred to the electrostatic image of the photosensitive member 1.

The toner image formed on the photosensitive member 1 is transported to a primary transfer portion N1, and then electrostatically transferred onto the intermediate transfer member 5 by applying a primary transfer bias having an opposite polarity to the proper polarity of the toner to the primary transfer roller 61. The toner image is then transported in the direction indicated by arrow c. Then, the toner image transported to a secondary transfer portion N2 is transferred onto the transfer material P by applying a secondary transfer bias having a polarity opposite to the proper polarity of the toner to the secondary transfer roller 62, and is transported to the fuser 7. The toner image is heated and pressed in the fuser 7, and, thereby, the toner T is fixed on the surface of the transfer material P. The transfer material P is then discharged as an output image from the apparatus.

After transferring, the toner T remaining on the photosensitive member 1 is removed by the cleaner 8. The photosensitive member 1 cleaned by the cleaner 8 is electrically initialized by being exposed to light from the exposure device 9, and is thus used repeatedly for forming images.

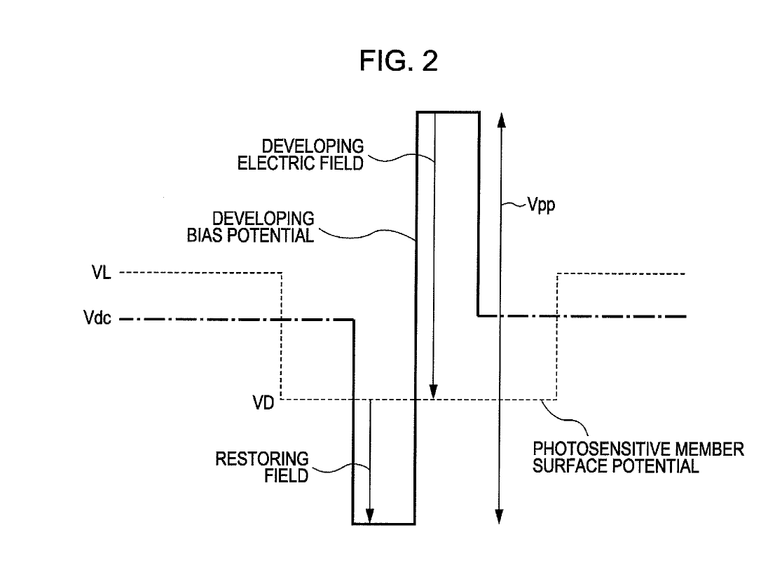

FIG. 2 shows the potential of an electrostatic image on the photosensitive member 1 and a developing bias applied to the developing sleeve 41 for development. In FIG. 2, the lateral axis represents the time, and the vertical axis represents the potential.

In the present embodiment, general rectangular waves (alternating electric field) are used as the developing bias. This developing bias is produced by superimposing a direct bias component (Vdc) on an alternating bias (peak-to-peak voltage Vpp). The developing bias is applied to the developing sleeve 41 to form an electric field between the photosensitive member 1 and the developing sleeve 41. The present inventors have found from a study that the effect of the α value of the carrier to enhance the developability is reduced as the peak-to-peak voltage Vpp is reduced. This is probably because the α value of the carrier of an embodiment of the invention tends to be reduced by increasing the intensity of the electric field applied, as shown in FIG. 12. Hence, since the substantial intensity of the electric field applied to the carrier is reduced by reducing the peak-to-peak voltage Vpp of the developing bias, the effect of the internal polarization of the carrier by the spread of time constant distribution can be reduced. In contrast, if the peak-to-peak voltage Vpp of the developing bias is increased to a specific value or more, the amount of development charge injection tends to increase and a white dotted image is produced by leakage between the developing sleeve and the photosensitive drum. It is accordingly preferably that the developing bias applied to the developing sleeve has a peak-to-peak voltage Vpp in the range of 0.7 to 1.8 kV from the viewpoint of forming a high-quality image while the effect of the spread of time constant distribution in the carrier is ensured.

VD in FIG. 2 represents the charged potential of the photosensitive member 1. The photosensitive member 1 is negatively charged by the charger 2 in the present embodiment. VL represents the potential of the region of an image exposed to light from the exposure device 3 and at which a maximum density is obtained. In other words, the highest amount of toner is deposited onto the VL potential region.

The developing sleeve 41 receives a developing bias having the above-described rectangular waves. When a Vp1 potential of peak potentials is applied to the developing sleeve 41, a largest potential difference from the VL potential occurs, and this potential difference forms an electric field (hereinafter referred to as developing electric field) to transport the toner to the photosensitive member 1 side. In contrast, when a Vp2 potential is applied to the developing sleeve 41, a potential difference from the VL potential occurs in the opposite direction from when the developing electric field is formed. This potential difference produces an electric field (hereinafter referred to as pullback electric field) to pull back the toner from the VL potential region to the developing sleeve 41 side, and thus the toner is transported to the developing sleeve 41 side.

In the present embodiment, the electrostatic latent image is formed by an image exposing method in which an electrostatic image is formed by exposing an image to light. Also, in the present embodiment, the photosensitive member 1 is negatively charged. In addition, the toner is negatively charged by friction with the carrier, and the development is performed by a reversal development method using a toner charged to the same polarity as the polarity of the photosensitive member (developing an exposed image region on the photosensitive member).

Parameter α obtained by fitting the frequency dependence of the impedance Z obtained by measuring alternating current impedance, using the fitting function expressed by equation (1) will now be described in detail with reference to drawings.

The α value of the carrier or the core particles can be measured by the following procedure.

First, the carrier or carrier core particles to be measured are weighed out so that when the carrier or core particles are enclosed in a sample holder having cylindrical electrodes (diameter: 2.5 cm) having an area of 4.9 cm² and a pressure of 100 N is applied between the electrodes, the thickness L of the sample becomes in the range of 0.95 to 1.05 mm.

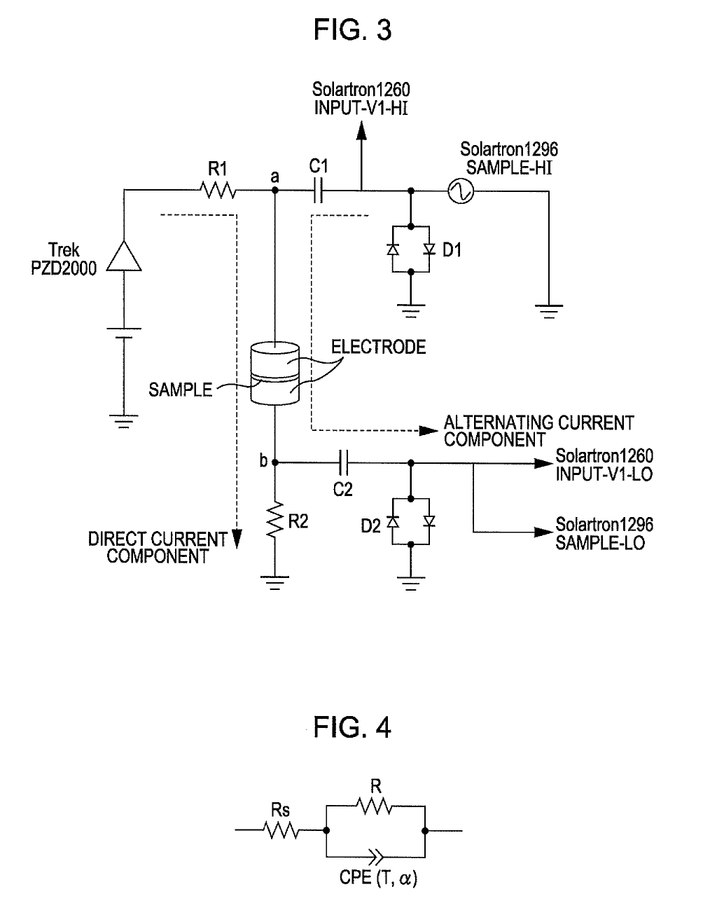

As shown in FIG. 3, wiring is provided between the electrodes of the sample holder, and the alternating current impedance of the carrier or core particles enclosed in the sample holder is measured with a pressure of 100 N applied between the electrodes.

In order to obtain the α value in an electric field, in the present embodiment, the alternating current impedance is measured in a state where a direct current is applied. Accordingly, as shown in FIG. 3, an alternating bias produced by superimposing a direct-current voltage Vo on a sine wave voltage Vac is applied between the electrodes of the sample holder. In addition, only the alternating current component of the response current flowing between the developing sleeve and the photosensitive drum at this time is extracted and analyzed to measure the impedance in a direct electric field.

For measuring the impedance, for example, a frequency response analyzer (FRA) Model 1260 and a dielectric constant measuring interface Model 1296, both manufactured by Solartron, may be used.

The direct-current voltage Vo used for the alternating bias is obtained by amplifying a direct voltage signal output from a waveform oscillator with, for example, a high voltage source PZD 2000 produced by Trek. The sine wave voltage Vac is output from the SAMPLE-HI terminal of the dielectric constant measuring interface Model 1296. Furthermore, the measuring system is provided with a capacitor C1 (66 μF) and a Zener diode D1 (5V), as shown in FIG. 3, and the alternating bias is thus obtained by superimposing a direct current voltage Vo on the sine wave voltage Vac.

The response current can be divided into a direct current component and an alternating current component by a shunt circuit including a resistor R2 (10 kΩ), a capacitor C2 (33 μF) and a Zener diode D2 (5V) shown in FIG. 3. Then, only the alternating current component flowing through the capacitor C2 is input to the INPUT-V1-LO terminal of the 1260 impedance analyzer and the SAMPLE-LO terminal of the 1296 dielectric constant measuring interface, and the waveform of the response current is analyzed to measure the impedance.

The resistor R1 (10 kΩ) shown in FIG. 3 is a protective resistor to limit the maximum current flowing to the measuring system.

In the examples of the invention, impedance was automatically measured using impedance measurement software SMaRT of Solartron. SMaRT can measure the complex impedance at a predetermined frequency f from the sine wave voltage at the frequency f and the response current at the sine wave voltage.

Z(ω)=Re[Z(ω)]+iIm[Z(ω)] (1)′

wherein Re[Z] represents the real part of an impedance and Im[Z] represents the imaginary part of the impedance; ω represents angular frequency, satisfying the relationship ω=2πf with frequency f.

In order to measure the frequency dependence of impedance, impedance was measured at a plurality of sine wave voltage frequencies from 1 Hz to 1 MHz. The effective amplitude of the sine wave voltage was set to 1 V.

Complex impedances Z measured at frequencies in the range of 1 Hz to 1 MHz were plotted on a complex plane, and thus a so-called Cole-Cole plot (Nyquist diagram) was prepared.

How the α value was obtained from complex impedance data of alternating current impedance measurement will now be described in detail.

The prepared Cole-Cole plot was fitted using the function of the Instant Fit function of analysis software ZView2 of Solartro, corresponding to the complex impedance of the equivalent circuit shown in FIG. 4, and the α was obtained as a fitting parameter of impedance measurement data.

In FIG. 4, Rs and R represents resistors, and CPE represents a circuit element called constant phase element. The frequency dependence of the complex impedance Z_{CPE} of CPE is expressed by the following equation (3):

$${Z}_{CPE} = \frac{1}{{( i ω )}^{α} T} \qquad ( 3 )$$

In the equation, ω represents the angular frequency for impedance measurement, and i represents the imaginary unit. α represents a dimensionless real number parameter of 0 to 1. Particularly when α is 1, equation (3) takes the same form as equation (4) expressing the impedance Zc of a capacitor. In this instance, T has the dimension of F (farad) corresponding to the capacitance C of the capacitor.

$${Z}_{C} = \frac{1}{i ω C} \qquad ( 4 )$$

The impedance of the entire equivalent circuit shown in FIG. 4 is expressed by the following equation, and finally by equation (1).

$$Z ( ω ) = Rs + {( 1 / R + 1 / {Z}_{CFE} )}^{- 1} \\ = Rs + {( 1 / R + 1 / {( {( i ω )}^{α} T )}^{- 1} )}^{- 1} \\ Z ( ω ) = {R}_{S} + \frac{R}{1 + {RT ( i ω )}^{α}} \qquad ( 1 )$$

Rs represents a virtual resistance introduced to the fitting circuit so as to increase the fitting accuracy, and may have a negative value.

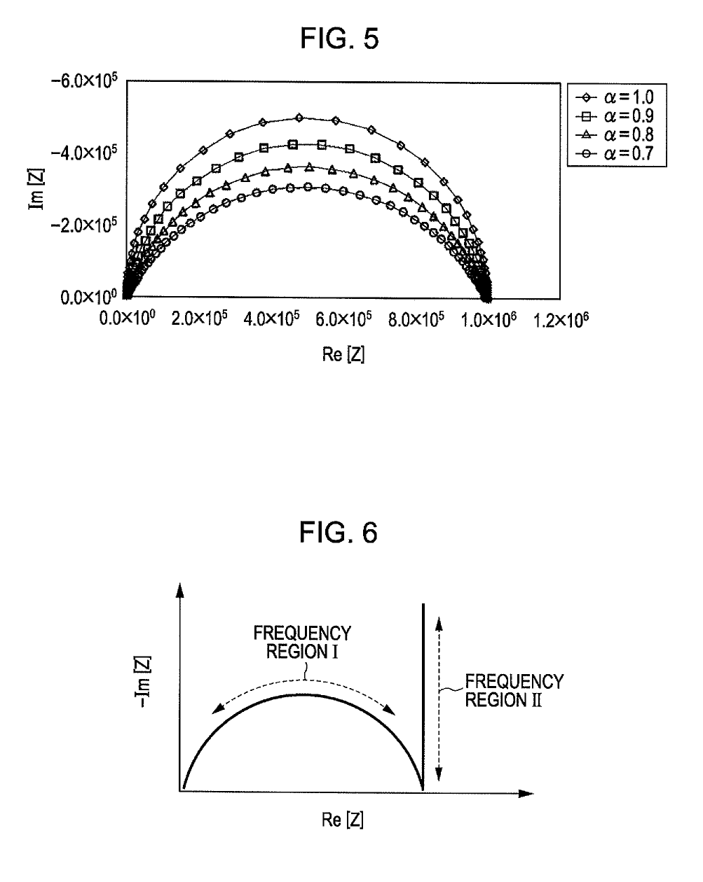

FIG. 5 is a Cole-Cole plot of the imaginary part (Im[Z]) plotted against the real part (Re[Z]) of ω when Rs=0Ω, R=1×10⁵Ω, T=2×10⁻¹⁰ F^{α}·Ω^{α-1}, and α=1.0, 0.9, 0.8, or 0.7 in equation (1). As is clear from the form of the Cole-Cole plot, α in equation (1) is a parameter corresponding to the distortion of the arcs formed by the Cole-Cole plot.

In the measuring system used in the present embodiment, the path of the alternating current component of the response current has capacitors C1 and C2 connected to the sample in series, as shown in FIG. 3. Accordingly, if the frequency for impedance measurement becomes relatively low, the impedance of the capacitors C1 and C2 may become higher than that of the sample. Then, the form of the Cole-Cole plot in frequency region II lying at the low frequency side may largely deviate from the arc, as shown in FIG. 6. In such a case, fitting for obtaining α is performed in frequency region I having high frequencies where the Cole-Cole plot forms an arc, using the equivalent circuit shown in FIG. 4.

### α in an Electric Field

The α value of the carrier in an electric field of 10³ V/cm and the α value of the core particles in an electric field of 10² V/cm were obtained as below.

The average intensity Esample of the electric field applied to the sample for measuring impedance is expressed by Vsample/L, wherein Vsample represents the direct current component of the voltage shared by the sample between the electrodes during impedance measurement, and L represents the distance between the electrodes. Vsample can be obtained by measuring the difference between the potential at point a (between R1 and C1) and the potential at point b (at which the sample line diverges to R2 and C2) in the circuit shown in FIG. 3. In the examples of the invention, the potentials at points a and b were measured with a Tktronix high-voltage probe P6015A, and the shared voltage Vsample between the electrodes of the sample holder was obtained from the potential difference. The Vsample value was adjusted by varying the direct-current voltage Vo output from a high voltage source.

Impedance measurement was thus performed in electric fields having different intensities E, and α values at different intensities were plotted on a graph. Thus, the α value of the carrier in an electric field of 10³ V/cm and the α value of the core particles in an electric field of 10² V/cm were estimated.

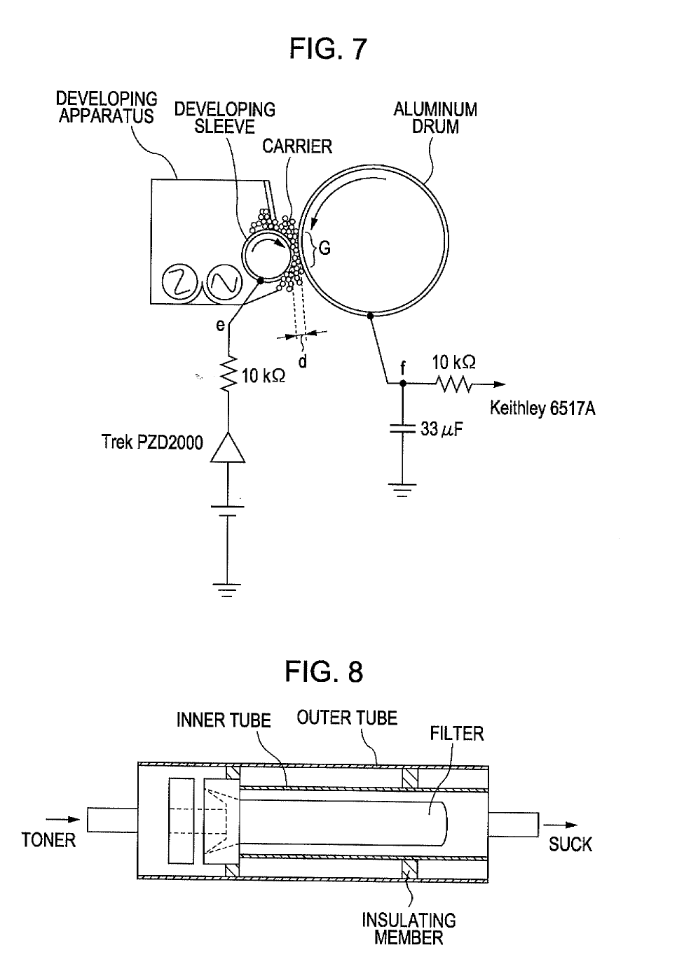

The dynamic electric resistivity p of the carrier in a magnetic brush state in an electric field of 10⁴ V/cm can be measured in the configuration shown in FIG. 7. The measurement of electric resistance performed by the following procedure is called dynamic resistance measurement. First, the developing sleeve of a developing unit containing only a carrier is opposed to an aluminum cylindrical body (hereinafter referred to as aluminum drum) rotating at a peripheral speed of 300 mm/s with a predetermined distance D (=270 μm), and the developing sleeve is rotated at a speed of 540 mm/s toward the same direction as the rotation of the aluminum drum. In this state, the direct current of the carrier in a magnetic brush state between the developing sleeve and the aluminum drum was measured. The amount of carrier transported on the developing sleeve was controlled to 30 mg/cm² by a control member of the developing unit.

The dynamic electric resistance of the carrier was obtained by applying a direct-current voltage Vo between the developing sleeve and the aluminum drum and measuring the direct current flowing between them. A Trek high voltage source PZD2000 was used as the direct voltage source. The current flowing between the developing sleeve and the aluminum drum was passed through a low-pass filter including a capacitor and a resistor to remove high-frequency noises, and then the direct current I (A) was measured with a Keithley electrometer 6517A.

Specifically, the measurement was performed as below. First, the shared voltage Vsd between the developing sleeve and the aluminum drum and the current I flowing between the developing sleeve and the aluminum drum were measured while the applied voltage Vo was varied, and the logarithm log [J/(A/cm²)] of current density J was plotted against the square root Esd^{1/2} of electric field intensity Esd. For obtaining the electric field intensity Esd, the potentials at points e and f in FIG. 7 were measured with a Tktronix high voltage probe P6015A, and Vsd/D was calculated using the shared voltage Vsd between the developing sleeve and the aluminum drum obtained from the potential difference and the distance D between the sleeve and the drum. The current density J was calculated from I/S using the measured current I and the area S (12.8 cm²) of the magnetic brush of the carrier transported onto the developing sleeve and brought into contact with the aluminum drum.

The reason why log [J/(A/cm²)] was plotted against Esd^{1/2} is that an electrophotographic development carrier in a high electric field often has a relationship expressed by (5) between applied electric field E and current density J.

$$log [ \frac{J}{{J}_{0}} ] ∝ \sqrt{E} \qquad ( 5 )$$

This is described in detail in Yasushi Hoshino, “Conductivity Mechanism in Magnetic Brush Developer”, Jpn. J. Appl. Phys., 19 (1980) pp. 2413-2416.

Thus, the J value at Esd=10⁴ V/cm was estimated from the plot prepared as above (or by interpolation when the highest Esd of plotted data was 10⁴ V/cm or more), and p was calculated from equation (6):

$$J = \frac{Esd}{ρ} \qquad ( 6 )$$

When the highest Esd of plotted data was 10⁴ V/cm or less, α and J at Esd=10⁴ V/cm were estimated by extrapolation to Esd=10⁴ V/cm, and ρ was calculated from equation (6).

Measurements of volume-based D50 of magnetic carrier particles and porous magnetic core particles, and volume-based D50 and D90 of pulverized calcined ferrite

Particle size distribution measurement was performed with a laser diffraction/scattering particle size distribution analyzer Microtrac MT3300EX (manufactured by Nikkiso).

For the measurement of the volume-based D50 and D90 of pulverized calcined ferrite, a wet-type sample circulating apparatus “Sample Delivery Control(SDC)” (manufacture by Nikkiso) was installed. Calcined ferrite (ferrite slurry) was added into the sample circulating apparatus to a measurement concentration. The flow rate was set at 70%; the ultrasonic power, 40 W; and the ultrasonic application time, 60 s.

The measurement was performed under the following conditions:

Set Zero time: 10 s

Measuring time: 30 s

Number of measurements: 10

Refractive index of solvent: 1.33

Refractive index of particles: 2.42

Shape of particles: nonspherical

Measurement upper limit: 1408 μm

Measurement lower limit: 0.243 μm

Measurement environment: 23° C./50% RH

For the measurement of volume-based D50 of magnetic carrier particles and porous magnetic core particles, a dry-type sample feeder “One-shot dry Sample Conditioner Turbotrac” (manufacture by Nikkiso) was installed. Turbotrac was used for sample supply with a dust collector as a vacuum source under the conditions of an air flow rate of about 33 L/s and a pressure of about 17 kPa. The measurement was automatically controlled by software. The D50 and D90 were obtained from a cumulative volume distribution. Software (Version 10. 3. 3-202D) supplied with the analyzer was used for control and analysis of the measurement.

The measurement was performed under the following conditions:

Set Zero time: 10 s

Measuring time: 10 s

Number of measurements: 1

Refractive index of particles: 1.81

Shape of particles: nonspherical

Measurement upper limit: 1408 μm

Measurement lower limit: 0.243 μm

Measurement environment: 23° C./50% RH

Weight-average particle size (D4) of toner and percentage of number of particles of 4.0 μm or less in particle size in toner

The weight-average particle size (D4) of the toner was measured by a pore electric resistance method with a 100 μm-aperture tube, using a precise particle size distribution analyzer “Multisizer 3 Coulter Counter” (registered trademark) manufactured by Beckman Coulter and software Multisizer 3 Version 3. 51 supplied from Beckman Coulter with the analyzer for setting measuring conditions and analyzing measurement data. The effective number of measurement channels was 25,000.

For the measurement, an electrolyte solution prepared by dissolving highest-quality sodium chloride in ion exchanged water to prepare about 1% by mass of solution, such as ISOTON II (produced by Beckman Coulter), can be used.

Before measurement and analysis, the software was set up as below.

The total count in the control mode is set to 50000 particles on the “standard measurement (SOM) change screen” of the software. Also, the number of measurements is set to 1, and Kd is set to a value obtained by use of “10.0 μm standard particles” (produced by Beckman Coulter). On pressing the threshold/noise level measurement button, the threshold and noise level are automatically set. The count is set to 1600 μA; the gain, to 2; and the electrolyte solution, to ISOTON II. A checkmark is placed at the statement of “flush of aperture tube after measurement”.

On the “Pulse-to-Particle Size Conversion Setting Screen” of the software, the bin distance is set to logarithmic particle size, the particle size bin to 256 particle size bins, and the particle size range to 2 to 60 μm.

Specifically, the measurement is performed according to the following procedure:

(1) About 200 mL of the electrolyte is placed in a Multisizer-3-specific 250 mL glass round bottom beaker, and stirred with a stirrer rod counterclockwise at 24 revolutions per second with the beaker set on a sample stand. The dirt and air bubbles in the aperture tube are removed by the “Aperture Flush” function of the software.
(2) About 30 mL of the electrolyte is placed in a 100 mL glass flat bottom beaker, and about 0.3 mL of dispersant “CONTAMINON N” dilute solution is added to the electrolyte. CONTAMINON N is a 10% by mass aqueous solution of a pH 7 neutral detergent for precision measurement instruments containing a nonionic surfactant, an anionic surfactant, and an organic binder, produced by Wako Pure Chemical Industries, and the dilute solution of CONTAMINON N is prepared by diluting CONTAMINON N to three times its mass with ion exchanged water.
(3) About 2 mL of CONTAMINON N is added to a predetermine amount of ion-exchanged water in a water tank of an ultrasonic dispersion system Tetora 150 (manufactured by Nikkaki Bios) having an electric power of 120 W, containing two oscillators of 50 kHz in oscillation frequency in a state where their phases are shifted by 180°.
(4) The beaker of the above (2) is set to a beaker securing hole of the ultrasonic dispersion system, and the ultrasonic dispersion system is started. Then, the level of the beaker is adjusted so that the resonance of the surface of the electrolyte solution in the beaker can be highest.
(5) With ultrasonic waves applied to the electrolyte solution in the beaker, about 10 mg of toner is added little by little to the electrolyte and dispersed. Such ultrasonic dispersion is further continued for 60 seconds. For the ultrasonic dispersion, the water temperature in the water tank is appropriately controlled in the range of 10 to 40° C.
(6) The electrolyte solution containing the toner is dropped using a pipette into the round bottom beaker of the above (1) set on the sample stand to adjust the measurement concentration to about 5%. Then, the measurement is performed until the number of measured particles comes to 50000.
(7) The measurement data is subjected to analysis of the software to calculate the weight-average particle size (D4). Here, “Average size” on the “Analysis/Volume Statistic Value (Arithmetic Mean) screen” in a state where graph/% by volume is set on the software refers to the weight average particle size (D4).

The percentage of the number of particles of 4.0 μm or less in size in the toner is calculated by analysis of measurement data of Multisizer 3.

The software is set to graph/% by number so that the chart of measurement results is expressed in terms of percent by number. Then, a checkmark is placed at a mark “<” in the particle size setting area on the “Format/Particle Size/Particle Size Statistics screen”, and “4” is input in the particle size input area below the checkmark. The value in the area where “<4 μm” is shown on the “Analysis/Number Statistic Value (Arithmetic Mean) screen” represents the percentage of the number of particles of 4.0 μm or less in size in the toner.

Measurement of peak molecular weight (Mp), number average molecular weight (Mn) and weight average molecular weight (Mw) of resin or toner

The peak molecular weight (Mp), the number average molecular weight (Mn) and the weight average molecular weight (Mw) can be measured by gel permeation chromatography (GPC) as below.

First, the sample is dissolved in tetrahydrofuran (THF) at room temperature over a time period of 24 hours. The sample may be resin or toner. The resulting solution is filtered through a solvent-resistant membrane filter “Maeshori disk” of 0.2 μm in pore size (manufacture by Tosoh Corporation) to prepare a sample solution. The sample solution is adjusted so that the content of component soluble in THF will be about 0.8% by mass. The resulting sample is subjected to measurement under the following conditions:

Instrument: HLC 8120 GPC (Detector: RI) (manufacture by Tosoh)

Column: 7 columns of Shodex KF-801, 802, 803, 804, 805, 806, and 807 in series (manufactured by Showa Denko)

Eluant: Tetrahydrofuran (THF)

Flow rate: 1.0 mL/min

Oven temperature: 40.0° C.

Amount of sample injected: 0.10 mL

For calculating the molecular weight of the sample, a molecular weight calibration curve is prepared using Standard polystyrene resins (for example, TSK Standard Polystyrenes F-850, F-450, F-288, F-128, F-80, F-40, F-20, F-10, F-4, F-2, F-1, A-5000, A-2500, A-1000, and A-500 (produced by Tosoh)).

Maximum endothermic peak temperature of wax and glass transition temperature Tg of binding resin or toner

The maximum endothermic peak temperature of the wax is measured according to ASTM D3418-82 with a differential scanning calorimeter Q1000 (manufacture by TA Instruments).

The temperature of the detector of the apparatus is compensated using the melting points of indium and zinc, and the heat quantity is compensated using the heat of fusion of indium.

Specifically, 10 mg of wax is weighed out and placed in an aluminum pan. Measurement was performed at a measuring temperature in the range of 30 to 200° C. at a heating rate of 10° C./min, using an empty aluminum pan as a reference. In the measurement, the sample is heated to 200° C. once, subsequently cooled to 30° C., and then heated again. The maximum endothermic peak of the DSC curve at temperatures in the range of 30 to 200° C. measured in the second heating step is defined as the maximum endothermic peak of the wax.

For measuring the glass transition temperature (Tg) of binding resin or toner, about 10 mg of binding resin or toner is weighed out and measured in the same manner as the measurement of the maximum endothermic peak temperature of wax. Then, the specific heat is varied in the range of 40 to 100° C. The glass transition temperature Tg of the binding resin or toner is defined by the intersection of the line through the midpoint of the baselines before and after the change in specific heat and the differential thermal curve.

### EXAMPLES

### Preparation of Porous Ferrite Core Particles 1

### Step 1 (Weighing and Mixing):

Ferrite raw materials were weighed out to prepare the following composite:

Fe₂O₃ 58.6% by mass

MnCO₃ 34.2% by mass

Mg(OH)₂ 5.7% by mass

SrCO₃ 1.5% by mass

Subsequently, the raw materials were pulverized and mixed in a dry ball mill with zirconia balls (diameter: 10 mm) for 2 hours.

### Step 2 (Calcining):

After the pulverization and mixing, the mixture was calcined in the air in a burner furnace at 950° C. for 2 hours to prepare a calcined ferrite.

The resulting ferrite is expressed by the following compositional formula:

(MnO)_{0.39}(MgO)_{0.13}(SrO)_{0.01}(Fe₂O₃)_{0.47}

### Step 3 (Pulverization):

The calcined ferrite was crushed into a particle size of about 0.3 mm with a crusher. Then, 30 parts by mass of water was added to 100 parts by mass of calcined ferrite, and the ferrite was pulverized in a wet ball mill using stainless balls of 10 mm in diameter for 1 hour. The resulting mixture was further pulverized in a wet bead mill using zirconia beads of 1.0 mm in diameter for 1 hour to prepare ferrite slurry (pulverized calcined ferrite) 1A. The pulverized calcined ferrite had a volume-based D50 of 1.7 μm and a volume-based D90 of 6.7 μm, and hence D90/D50 was 3.9.

### Step 4 (Weighing and Mixing):

Ferrite raw materials were weighed out to prepare the following composition:

Fe₂O₃ 80.8% by mass

MnCO₃ 25.8% by mass

Mg(OH)₂ 2.5% by mass

Subsequently, the raw materials were pulverized and mixed in a dry ball mill with zirconia balls (diameter: 10 mm) for 2 hours.

### Step 5 (Calcining):

After the pulverization and mixing, the mixture was calcined in the air in a burner furnace at 950° C. for 2 hours to prepare a calcined ferrite.

The resulting ferrite is expressed by the following compositional formula: (MnO)_{0.29}(MgO)_{0.06}(Fe₂O₃)_{0.65}

### Step 6 (Pulverization):

The calcined ferrite was crushed into a particle size of about 0.3 mm with a crusher. Then, 30 parts by mass of water was added to 100 parts by mass of calcined ferrite, and the ferrite was pulverized in a wet ball mill using zirconia balls of 10 mm in diameter for 3 hour.

The resulting mixture was further pulverized in a wet bead mill using alumina beads of 1.0 mm in diameter for 2 hours to prepare ferrite slurry (pulverized calcined ferrite) 1B.

The pulverized calcined ferrite had a volume-based D50 of 1.3 μm and a volume-based D90 of 2.1 μm, and hence D90/D50 was 1.6.

### Step 7 (Granulation):

Ferrite slurries 1A and 1B were mixed in a ratio of 1:1, and 2.0 parts by mass of polyvinyl alcohol was added as a binder to 100 parts by mass of the calcined ferrite mixture. The resulting mixture was granulated into spherical particles with a spray dryer (manufactured by Ohkawara Kakohki). D90/D50 of the pulverized calcined ferrite prepared from the ferrite slurry mixture was 4.2.

### Step 8 (Firing):

The granulated ferrite was fired in an electric furnace under the controlled condition where the temperature was increased to 1150° C. over a period of 4 hours in a nitrogen atmosphere (containing 0.3% by volume of oxygen) and the temperature of 1150° C. was kept for 4 hours. After the furnace was cooled to room temperature over a period of 3 hours, the resulting porous ferrite core was taken out.

### Step 9 (Screening):

After pulverizing the aggregate of the particles, coarse particles were removed through a sieve having openings of 250 μm, and, thus, porous ferrite core particles 1 having a volume-based D50 of 34.5 μm were obtained.

### Preparation of Porous Ferrite Core Particles 2

Porous ferrite core particles 2 were prepared in the same manner as the porous ferrite core particles 1 except that the oxygen content in the firing atmosphere was reduced to less than 0.01% by volume in Step 8 (Firing). The resulting porous ferrite core particles 2 have a volume-based D50 of 33.5 μm.

### Preparation of Porous Ferrite Core Particles 3

Porous ferrite core particles 3 were prepared in the same manner as the porous ferrite core particles 1 except that the oxygen content in the firing atmosphere was controlled to 1.0% by volume in Step 8 (Firing). The resulting porous ferrite core particles 3 have a volume-based D50 of 35.7 μm.

### Preparation of Porous Ferrite Core Particles 4

Step 1 (Weighing and mixing):

Ferrite materials were weighed out to prepare the following composition:

Fe₂O₃ 67.0% by mass

MnCO₃ 26.3% by mass

Mg(OH)₂ 6.7% by mass

Subsequently, the raw materials were pulverized and mixed in a dry ball mill with zirconia balls (diameter: 10 mm) for 2 hours.

### Step 2 (Calcining):

After the pulverization and mixing, the mixture was calcined in the air in a burner furnace at 950° C. for 2 hours to prepare a calcined ferrite.

The resulting ferrite is expressed by the following compositional formula:

(MnO)_{0.30}(MgO)_{0.15}(Fe₂O₃)_{0.55}

### Step 3 (Pulverization):

The calcined ferrite was crushed into a particle size of about 0.3 mm with a crusher. Then, 30 parts by mass of water was added to 100 parts by mass of calcined ferrite, and the ferrite was pulverized in a wet ball mill using zirconia balls of 10 mm in diameter for 2 hours.

The resulting mixture was further pulverized in a wet bead mill using zirconia beads of 1.0 mm in diameter for 2 hours to prepare a ferrite slurry (pulverized calcined ferrite).

The pulverized calcined ferrite had a volume-based D50 of 1.8 μm and a volume-based D90 of 7.0 μm, and hence D90/D50 was 3.9.

### Step 4 (Granulation):

To 100 parts by mass of the ferrite slurry were added 2.0 parts by mass of polyvinyl alcohol (weight average molecular weight: 5000) and 10 parts by mass of spherical SiO₂ particles having a weight-average particle size of 4 μm as binders, 1.5 parts by mass of ammonium polycarboxylate as a dispersant, and 0.05 parts by mass of nonionic activator as a wetting agent. The mixture was granulated into spherical particles with a spray dryer (manufactured by Ohkawara Kakohki).

### Step 5 (Firing):

The granulated ferrite was fired in an electric furnace under the controlled condition where the temperature was increased to 1200° C. over a period of 4.5 hours in a nitrogen atmosphere (containing 0.1% by volume of oxygen) and the temperature of 1200° C. was kept for 4 hours. After the furnace was cooled to room temperature over a period of 3 hours, the resulting porous ferrite core was taken out.

### Step 6 (Screening):

After pulverizing the aggregate of the particles, coarse particles were removed through a sieve having openings of 250 μm, and, thus, porous ferrite core particles 4 having a volume-based D50 of 37.5 μm were obtained.

### Preparation of Ferrite Core Particles 5

### Step 1:

Raw materials of ferrite were weighed out to prepare the following composition:

Fe₂O₃ 74.8% by mass

CuO 11.2% by mass

ZuO 14.0% by mass

Subsequently, the raw materials were pulverized and mixed in a dry ball mill with zirconia balls (diameter: 10 mm) for 2 hours.

### Step 2 (Calcining)

After the pulverization and mixing, the mixture was calcined in the air at 950° C. for 2 hours to prepare a calcined ferrite. The resulting ferrite is expressed by the following compositional formula: (CuO)_{0.18}(ZnO)_{0.22}(Fe₂O₃)_{0.60}

The above compositional formula of the ferrite represents only principal elements, and the ferrite may contain other trace metals.

### Step 3:

The calcined ferrite was crushed into a particle size of about 0.5 mm with a crusher. Then, 30 pars by mass of water was added to 100 parts by mass of calcined ferrite, and the ferrite was pulverized in a wet ball mill using stainless balls of 10 mm in diameter for 7 hours.

The resulting pulverized calcined ferrite had a volume-based D50 of 1.8 μm and a volume-based D90 of 2.9 μm, and hence D90/D50 was 3.6.

### Step 4:

To 100 parts by mass of the pulverized calcined ferrite was added 0.5 parts by mass of polyvinyl alcohol as a binder. The mixture was granulated into spherical particles with a spray dryer (manufactured by Ohkawara Kakohki).

### Step 5 (Firing):

The granulated ferrite was fired in an electric furnace under the controlled condition where the temperature was increased to 1300° C. over a period of 5.0 hours in a nitrogen atmosphere (containing 0.1% by volume of oxygen) and the temperature of 1300° C. was kept for 4 hours. After the furnace was cooled to room temperature over a period of 4 hours, the resulting ferrite core was taken out.

### Step 6:

After pulverizing the aggregate of the particles, coarse particles were removed through a sieve having openings of 250 μm, and, thus, ferrite core particles 5 having a volume-based D50 of 48.5 μm were obtained.

### Preparation of Resin Solution A

Silicones varnish (SR2410Dow, produced by Corning Toray, solid content 20% by mass): 83.3 parts by mass
Toluene: 16.7 parts by mass
γ-aminopropyltriethoxysilane: 1.5 parts by mass
These materials were mixed in a ball mill (soda glass ball: diameter: 10 mm) for 1 hour to yield resin solution A.

### Preparation of Porous Ferrite Core Particles 6

Step 1 (Weighing and mixing):

Ferrite materials were weighed out to prepare the following composition:

Fe₂O₃ 80.8% by mass

MnCO₂ 25.8% by mass

Mg(OH)₂ 2.5% by mass

Subsequently, the raw materials were pulverized and mixed in a dry ball mill with zirconia balls (diameter: 10 mm) for 2 hours.

### Step 2 (Calcining):

After the pulverization and mixing, the mixture was calcined in the air in a burner furnace at 950° C. for 2 hours to prepare a calcined ferrite.

The resulting ferrite is expressed by the following compositional formula:

(MnO)_{0.29}(MgO)_{0.06}(Fe₂O₃)_{0.65}

### Step 3 (Pulverization):

The calcined ferrite was crushed into a particle size of about 0.3 mm with a crusher. Then, 30 parts by mass of water was added to 100 parts by mass of calcined ferrite, and the ferrite was pulverized in a wet ball mill using zirconia balls of 10 mm in diameter for 5 hours.

The resulting mixture was further pulverized in a wet bead mill using alumina beads of 1.0 mm in diameter for 3 hours to prepare a ferrite slurry (pulverized calcined ferrite).

The pulverized calcined ferrite had a volume-based D50 of 0.9 μm and a volume-based D90 of 1.2 μm, and hence D90/D50 was 1.3.

### Step 4 (Granulation):

To 100 parts by mass of the pulverized calcined ferrite was added 2.0 parts by mass of polyvinyl alcohol as a binder. The mixture was granulated into spherical particles with a spray dryer (manufactured by Ohkawara Kakohki).

### Step 5 (Firing):

The granulated ferrite was fired in an electric furnace under the controlled condition where the temperature was increased to 1150° C. over a period of 4 hours in a nitrogen atmosphere (containing 0.3% by volume of oxygen) and the temperature of 1150° C. was kept for 4 hours. After the furnace was cooled to room temperature over a period of 3 hours, the resulting porous ferrite core was taken out.

### Step 6 (Screening):

After pulverizing the aggregate of the particles, coarse particles were removed through a sieve having openings of 250 μm, and, thus, porous ferrite core particles 6 having a volume-based D50 of 33.6 μm was obtained.

### Preparation of Porous Ferrite Core Particles 7

Porous ferrite core particles 7 were prepared in the same manner as Porous ferrite core particles 1 except that only ferrite slurry 1B was used without using ferrite slurry 1A. The resulting porous ferrite core particles 7 have a volume-based D50 of 34.7 μm.

### Preparation of Porous Ferrite Core Particles 8

### Step 1 (Weighting and Mixing):

Ferrite materials were weighed out to prepare the following composition:

Fe₂O₃ 58.6% by mass

MnCO₃ 34.2% by mass

Mg(OH)₂ 5.7% by mass

SrCO₃ 1.5% by mass

Subsequently, the raw materials were pulverized and mixed in a dry ball mill with zirconia balls (diameter: 10 mm) for 2 hours.

### Step 2 (Calcining):

After the pulverization and mixing, the mixture was calcined in the air in a burner furnace at 950° C. for 2 hours to prepare a calcined ferrite.

The resulting ferrite is expressed by the following compositional formula:

(MnO)_{0.39}(MgO)_{0.13}(SrO)_{0.01}(Fe₂O₃)_{0.47}

### Step 3 (Pulverization):

The calcined ferrite was crushed into a particle size of about 0.3 mm with a crusher. Then, 30 pars by mass of water was added to 100 parts by mass of calcined ferrite, and the ferrite was pulverized in a wet ball mill using stainless balls of 10 mm in diameter for 1 hour.

The resulting flurry was further pulverized in a wet bead mill using zirconia beads of 1.0 mm in diameter for 0.5 hours to prepare ferrite slurry (pulverized calcined ferrite) 2A. The pulverized calcined ferrite had a volume-based D50 of 2.3 μm and a volume-based D90 of 13.1 μm, and hence D90/D50 was 5.7.

### Step 4 (Weighing and Mixing):

Ferrite materials were weighed out to prepare the following composition:

Fe₂O₃ 80.8% by mass

MnCO₃ 25.8% by mass

Mg(OH)₂ 2.5% by mass

Subsequently, the raw materials were pulverized and mixed in a dry ball mill with zirconia balls (diameter: 10 mm) for 2 hours.

### Step 5 (Calcining):

After the pulverization and mixing, the mixture was calcined in the air in a burner furnace at 950° C. for 2 hours to prepare a calcined ferrite. The resulting ferrite is expressed by the following compositional formula:

(MnO)_{0.29}(MgO)_{0.06}(Fe₂O₃)_{0.65}

### Step 6 (Pulverization):

The calcined ferrite was crushed into a particle size of about 0.3 mm with a crusher. Then, 30 parts by mass of water was added to 100 parts by mass of calcined ferrite, and the ferrite was pulverized in a wet ball mill using zirconia balls of 10 mm in diameter for 5 hours. The resulting slurry was further pulverized in a wet bead mill using alumina beads of 1.0 mm in diameter for 5 hours to prepare ferrite slurry (pulverized calcined ferrite) 2B.

The pulverized calcined ferrite had a volume-based D50 of 0.6 μm and a volume-based D90 of 0.9 μm, and hence D90/D50 was 1.5.

### Step 7 (Granulation):

Ferrite slurries 2A and 2B were mixed in a ratio of 2:1, and 2.0 parts by mass of polyvinyl alcohol was added as a binder to 100 parts by mass of the calcined ferrite mixture. The mixture was granulated into spherical particles with a spray dryer (manufactured by Ohkawara Kakohki). D90/D50 of the pulverized calcined ferrite prepared from the ferrite slurry mixture was 8.1.

### Step 8 (Firing):

The granulated ferrite was fired in an electric furnace under the controlled condition where the temperature was increased to 1150° C. over a period of 4 hours in a nitrogen atmosphere (containing 0.3% by volume of oxygen) and the temperature of 1150° C. was kept for 4 hours. After the furnace was cooled to room temperature over a period of 3 hours, the resulting porous ferrite core was taken out.

### Step 9 (Screening):

After pulverizing the aggregate of the particles, coarse particles were removed through a sieve having openings of 250 μm, and, thus, porous ferrite core particles 8 having a volume-based D50 of 48.5 μm was obtained.

### Preparation of Porous Ferrite Carrier 1

A universal agitator (manufactured by Dalton) was charged with 100 parts by mass of porous ferrite core particles 1 and heated to 50° C. under reduced pressure. Resin solution A in an amount corresponding to 8.0 parts by mass of filling resin component was dropped to 100 parts by mass of porous ferrite core particles 1 over a period of 2 hours, followed by stirring for 1 hour at 50° C. Then, the solvent was removed by heating to 80° C. over a period of 1 hour. The resulting sample was transferred to JULIA MIXER (manufacture by Tokuju Corporation) and heat-treated at 180° C. in a nitrogen atmosphere for 2 hours. The heat-treated sample was classified through a mesh having openings of 70 μm to yield magnetic core 1 (filling resin content: 8.0 parts by mass).

Nauta Mixer (available from Hosokawa micron) was charged with 100 parts by mass of magnetic core 1, and the core was adjusted to a temperature of 80° C. under reduced pressure with the screw rotated at 100 min⁻¹ and the mixer rotated at 3.5 min⁻¹. Resin solution A was diluted with toluene so that its solid content would be 10% by mass, and the diluted resin solution was added so that the coating resin content would be 0.5 parts by mass relative to 100 parts by mass of magnetic core 1. The magnetic core particles were coated with the resin over a period of 2 hours while the solvent was removed. Subsequently, the sample was heated to 180° C., stirred for 2 hours, and cooled to 70° C. The resulting sample was transferred to JULIA MIXER (manufacture by Tokuju Corporation) and heat-treated at 180° C. for 4 hours in a nitrogen atmosphere. The heat-treated sample was classified through a sieve having openings of 70 μm to remove coarse particles, and, thus, porous ferrite carrier 1 having a volume-based D50 of 35.2 μm was completed.

### Preparation of Porous Ferrite Carrier 2

Porous ferrite carrier 2 was prepared in the same manner as porous ferrite carrier 1 except that resin solution A was added so that the coating resin content would be 1.0 parts by mass relative to 100 parts by mass of magnetic core 1, and followed by coating and removal of solvent. The resulting porous ferrite carrier 2 has a volume-based D50 of 35.5 μm.

### Preparation of Porous Ferrite Carrier 3

Porous ferrite carrier 3 was prepared in the same manner as porous ferrite carrier 1 except that resin solution A was added so that the coating resin content would be 2.0 parts by mass relative to 100 parts by mass of magnetic core 1, and followed by coating and removal of solvent. The resulting porous ferrite carrier 3 has a volume-based D50 of 35.9 μm.

### Preparation of Porous Ferrite Carrier 4

Porous ferrite carrier 4 was prepared in the same manner as porous ferrite carrier 1 except that porous ferrite core particles 2 were used as the porous ferrite core particles. The resulting porous ferrite carrier 4 has a volume-based D50 of 34.5 μm.

### Preparation of Porous Ferrite Carrier 5

Porous ferrite carrier 5 was prepared in the same manner as porous ferrite carrier 1 except that porous ferrite core particles 3 were used as the porous ferrite core particles. The resulting porous ferrite carrier 5 has a volume-based D50 of 36.8 μm.

### Preparation of Porous Ferrite Carrier 6

Nauta Mixer (available from Hosokawa micron) was charged with 100 parts by mass of porous ferrite core particles 4, and the core particles were adjusted to a temperature of 80° C. under reduced pressure with the screw rotated at 120 min⁻¹ and the mixer rotated at 3.5 min⁻¹. Resin solution A was diluted with toluene so that its solid content would be 10% by mass, and the diluted resin solution was added so that the coating resin content would be 0.5 parts by mass relative to 100 parts by mass of porous ferrite core particles 4. The porous ferrite core particles were coated with the resin over a period of 4 hours while the solvent was removed. Subsequently, resin solution A was added so that the coating resin content would be 0.5 parts by mass relative to 100 parts by mass of porous ferrite core particles 4. The porous ferrite core particles were coated with the resin over a period of 4 hours while the solvent was removed. Subsequently, the sample was heated to 180° C., stirred for 2 hours, and cooled to 70° C. The resulting sample was transferred to JULIA MIXER (manufacture by Tokuju Corporation) and heat-treated at 180° C. for 4 hours in a nitrogen atmosphere. The heat-treated sample was classified through a sieve having openings of 70 μm to remove coarse particles, and, thus, porous ferrite carrier 6 having a volume-based D50 of 38.3 μm was completed.

### Preparation of Porous Ferrite Carrier 7

Porous ferrite carrier 7 was prepared in the same manner as porous ferrite carrier 1 except that resin solution A was added so that the coating resin content would be 3.0 parts by mass relative to 100 parts by mass of magnetic core 1, and followed by coating and removal of solvent. The resulting porous ferrite carrier 7 had a volume-based D50 of 37.5 μm.

### Preparation of Porous Ferrite Carrier 8

Resin solution A was added so that the coating resin content would be 1.0% by mass relative to 100 parts by mass of magnetic core 1. The magnetic core particles were thus coated with resin with a fluidized bed heated to 80° C. and the solvent was removed. After coating and removal of solvent, the sample was heated to 200° C. and heat-treated for 2 hours. The heat-treated sample was classified through a sieve having openings of 70 μm to yield porous ferrite carrier 8. The resulting porous ferrite carrier 8 had a volume-based D50 of 35.4 μm.

### Preparation of Ferrite Carrier 9

Resin solution A was added so that the coating resin content would be 0.4% by mass relative to 100 parts by mass of ferrite core particles 5. The core particles were thus coated with resin with a fluidized bed heated to 80° C. and the solvent was removed. After coating and removal of solvent, the sample was heated to 200° C. and heat-treated for 2 hours. The heat-treated sample was classified through a sieve having openings of 70 μm to yield ferrite carrier 9. The resulting ferrite carrier 9 had a volume-based D50 of 49.7 μm.

### Preparation of Porous Ferrite Carrier 10

Porous ferrite carrier 10 was prepared in the same manner as porous ferrite carrier 1 except that porous ferrite core particles 6 were used as the porous ferrite core particles. The resulting porous ferrite carrier 10 had a volume-based D50 of 33.9 μm.

### Preparation of Ferrite Carrier 11

Porous ferrite carrier 11 was prepared in the same manner as porous ferrite carrier 1 except that porous ferrite core particles 7 were used as the porous ferrite core particles. The resulting porous ferrite carrier 11 had a volume-based D50 of 34.9 μm.

### Preparation of Porous Ferrite Carrier 12

Porous ferrite carrier 12 was prepared in the same manner as porous ferrite carrier 1 except that porous ferrite core particles 8 were used as the porous ferrite core particles. The resulting porous ferrite carrier 12 had a volume-based D50 of 48.9 μm.

### Preparation of Resin A

A dropping funnel was charged with 1.9 mol of styrene, 0.21 mol of 2-ethylhexyl acrylate, 0.15 mol of fumaric acid, 0.03 mol of α-methylstyrene dimer, and 0.05 mol of dicumyl peroxide. A 4 L four-neck glass flask was charged with 7.0 mol of polyoxypropylene(2.2)-2,2-bis(4-hydroxyphenyl)propane, 3.0 mol of polyoxyethylene(2.2)-2,2-bis(4-hydroxyphenyl)propane, 3.0 mol of terephthalic acid, 2.0 mol of trimellitic anhydride, 5.0 mol of fumaric acid, and 0.2 g of dibutyl tin oxide. The flask was equipped with a thermometer, a stirring stick, a capacitor and a nitrogen inlet tube, and was placed in a mantle heater. After the flask was subsequently purged with nitrogen gas, the mixture in the flack was slowly heated with stirring. Then, vinyl resin monomers, crosslinking agent and polymerization initiator were dropped into the flask from the dropping funnel over a period of 6 hours with stirring at 140° C. Subsequently, the mixture was heated to 200° C., and was reacted at 200° C. for 4 hours to yield Resin A.

The resulting resin A was subjected to gel permeation chromatography (GPC) to measure the molecular weight. As a result, Resin A had a weight average molecular weight (Mw) of 64000, a number average molecular weight (Mn) of 4500, and a peak molecular weight (Mp) of 7000. The glass transition temperature (Tg) was 59° C.

### Preparation of Cyan Masterbatch

The following materials were melted and kneaded in a kneader mixer to prepare a cyan masterbatch:

Resin A (for masterbatch) 60 parts by mass

C. I. Pigment Blue 15:3 40 parts by mass

### Preparation of Toner

The following materials were mixed with a Henschel mixer (FM-75, manufactured by Mitsui Miike Engineering):

Resin A 88.0 parts by mass;

Refined paraffin wax (maximum endothermic peak temperature: 70° C.) 5.0 parts by mass;

Cyan masterbatch prepared above (containing 40% by mass of coloring material) 20.0 parts by mass; and

di-tert-butylsalicylic acid aluminum compound (negative charge control agent) 0.3 parts by mass.

Then, the mixture was kneaded at 120° C. in a twin screw kneader (PCM-30, manufactured by Ikegai). The resulting mixture was cooled and pulverized to 1 mm or less with a hammer mill. The resulting pulverized material was further pulverized to much lower particle sizes with a mechanical pulverizer (T-250, manufactured by Turbo Kogyo). The resulting particles were classified with a Hosokawa Micron particle design system (product name: FACULTY). To 100 parts by mass of cyan toner particles was added 1.0 part by mass of hydrophobic silica fine particles that had been surface-treated with 20% by mass of hexamethyldisilazane to a primary average particle size of 16 nm. The materials were mixed by a Henschel mixer (FM-75, manufactured by Mitsui Miike Engineering) to yield toner A. The resulting toner A had a weight-average particle size (D4) of 6.1 μm. The percentage of particles having a particle size of 4.0 μm or less was 25.3% in terms of number of particles.

### Example 1

To 90 parts by mass of porous ferrite carrier 1 was added 10 parts by mass of toner A, and the materials were shaken by a V-blender for 10 minutes to yield a two-component developer. The carrier was evaluated using the resulting two-component developer.

### Image Properties

Evaluation of the image properties of the carrier will be described below.

In order to confirm that the carrier according to an embodiment of the invention is superior to known carriers in that it can prevent negative effects of development charge injection and provide high-quality images while ensuring sufficient image density, the carrier was evaluated for (1) developability, (2) graininess in the low-density portion, and (3) gradation in the low-density portion. The reason why the graininess in the low-density portion and the gradation in the low-density portion were examined for evaluating the image quality is that the low-density portion of the electrostatic latent image having a low potential is deformed most by development charge injection, and accordingly that the graininess and gradation failure in the output image become most conspicuous in the low density portion.

For the evaluation, a modified Canon image PRESS C1 was used as an image forming apparatus, and the black-position developing unit was charged with the above developer. Thus, images were formed at room temperature and normal humidity (23° C., 50% RH). Images were output on a transfer material, OK Top Coat+128 (128 g/cm²).

The developability was evaluated as below. The charge and exposure of the photosensitive drum were controlled so that the difference between the high-density image potential VL (−150 V in the present examples) and the non-image region potential VD (−400 V in the present examples) can be 450 V. The surface potential of the photosensitive drum was measured with a surface electrometer (MODEL 347, manufactured by Trek) located immediately under the developing region where the developing sleeve and the photosensitive drum oppose each other. The integral average Vdc of the developing bias voltage was set so that the development contrast Vcon (=|Vdc−VL|) would be 250 V and the back contrast Vback (=|VD−Vdc|) would be 150 V. A electrostatic latent image for a solid black image was formed on the photosensitive drum by charging and exposing the photosensitive drum, and was developed with the toner using the above-prepared two-component developer containing a carrier and a toner. Then, the rotation of the photosensitive drum was stopped before the toner layer formed on the photosensitive drum was transferred onto the intermediate transfer member, and the charge of the toner per unit area of the toner image (Q/S) was measured. The resulting value was evaluated as developability.

The Q/S value can be calculated by multiply the average frictional charge quantity Q/M of the toner image on the photosensitive drum by the amount per unit area M/S of the toner of the toner image (amount of toner on the photosensitive drum).

The average charge quantity Q/M of the toner image on the photosensitive member and the amount M/S of toner on the photosensitive drum were measured as below. The toner on the photosensitive drum is sucked using a Faraday cylinder including coaxially combined inner and outer metal tubes having different diameters and a filter for collecting the toner therein disposed in the inner tube. The inner tube and the outer tube of the Faraday cylinder were electrically isolated from each other. When the tone is introduced into the filter, the charge of the toner causes static induction. The quantity Q of induced charge was measured with a Keithley electrometer 6517A.

Then, the mass M of the toner was measured from the difference between the masses of the Faraday cylinder before and after suction, and the area S on the photosensitive drum from which the toner was sucked was measured. Thus, the average charge quantity Q/M of the toner and the amount M/S of toner on the photosensitive drum were obtained.

The developability was evaluated according to the following criteria:

A: Excellent, Q/S≧16.0 nC/cm²

B: Good, 15.00 nC/cm²≦Q/S<16.00 nC/cm²

C: Fair, 14.00 nC/cm²≦Q/S<15.00 nC/cm²

D: Poor, Q/S<14.00 nC/cm²

The graininess in the low-density image portion was evaluated as below.

First, the charge potential VD of the photosensitive drum and the integral average Vdc of the developing bias voltage were adjusted, and the development contrast Vcon was set so that the amount M/S of the toner of the solid image on the photosensitive drum would be 0.3 mg/cm² at a back contrast Vback (=|VD−Vdc|) of 150 V. Subsequently, a 16-step gradation digital latent image was formed on the photosensitive drum, followed by development, transfer, and fixation. Thus, a 16-step gradation image was output. The granularity GS of the resulting output image was calculated according to the following method, and the graininess in the low-density portion was evaluated according to the granularity GS when the output image had a lightness L* of 75.

For measuring the granularity of a silver halide photograph, RMS granularity σ_{D} is generally used which is the standard deviation of a density distribution Di. This measurement is specified in ANSI PJ-2. 40-1985 “root mean square (rms) granularity of film”.

$${σ}_{D} = \sqrt{\frac{1}{N} {\sum }_{i = 1}^{N} {( {D}_{i} - \overline{D} )}^{2}} \qquad ( 7 )$$

The granularity can be measured by using a Wiener spectrum being a power spectrum of density fluctuation. The Wiener spectrum of an image and the visual transfer function (VTF) are casketed, and then the integrated value is defined as the granularity (GS). A high GS value means that the image is undesirably grainy.

GS=exp(−1.8 D̅)∫\sqrt{WS(u)}·VTF(u)du (8)

Where u represents spatial frequency, WS(u) represents a Wiener spectrum, VTF (u) represents a virtual transfer function, and the term of exp(−1.8 D̅) represents a function with average density D as variable for compensating the difference between the density and the lightness that the human senses. (R. P. Dooley, R. Shaw: “Noise Perception in Electrophotography” J. Appl. Photogr. Eng. 5(4))

The graininess was evaluated according to the following criteria:

A: very fine, Granularity GS<0.170

B: fine, 0.170≦GS<0.180

C: fair, 0.180≦GS<0.190

D: grainy, GS≧0.190

The gradation in the low-density image portion was evaluated by effective gradation as below.

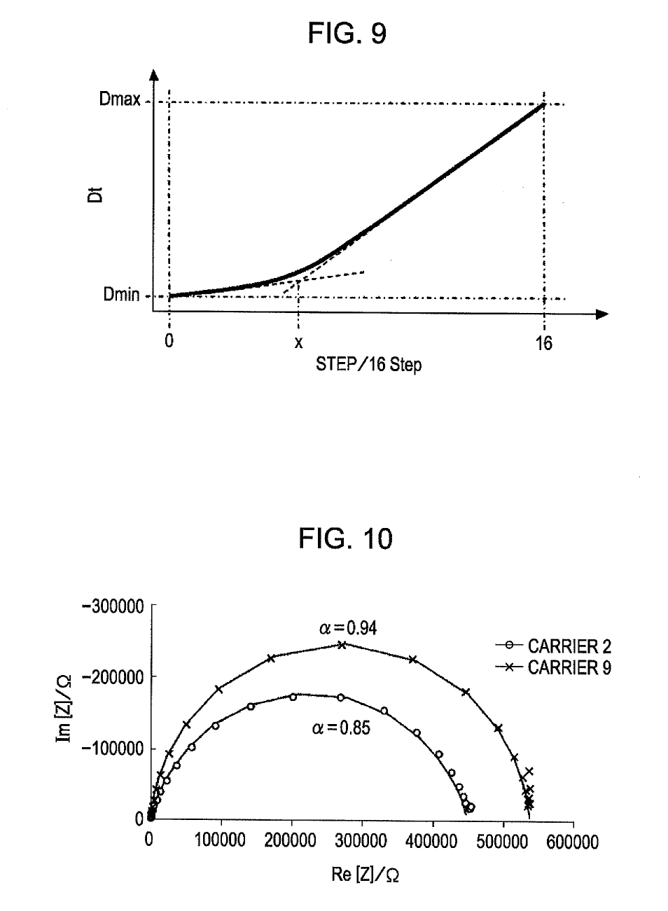

First, the above 16-step gradation image was measured for the transmission densities Dt at the respective steps, and a so-called γ curve was prepared as shown in FIG. 9. In FIG. 9, Dmax represents a measurement of the transmission density in the highest density image portion, and Dmin represents a measurement of the transmission density in the non-image portion. As the γ curve has higher linearity, the image has better gradation.

According to a sturdy of the present inventors, the latent image potential in the low-density image portion is shallower than that in the high-density image portion. If a charge is injected to a latent image potential by development charge injection, a toner image is not formed in the low-density image portion. Thus, the density is reduced in the low-density portion, as shown in FIG. 9, and the gradation does not appear (high γ occurs). The present inventors define the effective gradation by the following equation (9) using an inflection point x of the γ curve:

$$Effective gradation = \frac{16 - x}{16} \qquad ( 9 )$$

As the effective gradation calculated from Equation (9) is closer to 1, the rise of the γ curve is gentler and the gradation becomes better.

For evaluation, the transmission density Dt was measure with a Macbeth transmission density meter TD 904 in the red filter mode.

The gradation was evaluated according to the following criteria:

A: Excellent, effective gradation≧0.93

B: Good, 0.90≦effective gradation<0.93

C: Fair, 0.87≦effective gradation<0.90

D: Poor, effective gradation<0.87

### Examples 2 to 8, Comparative Examples 1 to 4

Two-component developers were prepared by combining ferrite carriers and toner A according to the table in the same manner as in Example 1. To 90 parts by mass of ferrite carrier was added 10 parts by mass of toner A, and the materials were mixed by a V-blender for 10 minutes to yield a developer. The resulting developer was subjected to evaluation.

### Evaluation Results

The table shows α and resistivity ρ of Carriers 1 to 12, α of core particles, and the results of the above-described evaluations.

FIG. 10 shows the Cole-Cole plots and fitting curves of Carriers 2 and 9, obtained by measuring the impedance. In FIG. 10, the data points represent measurements of impedance and the solid line represents the fitting results.

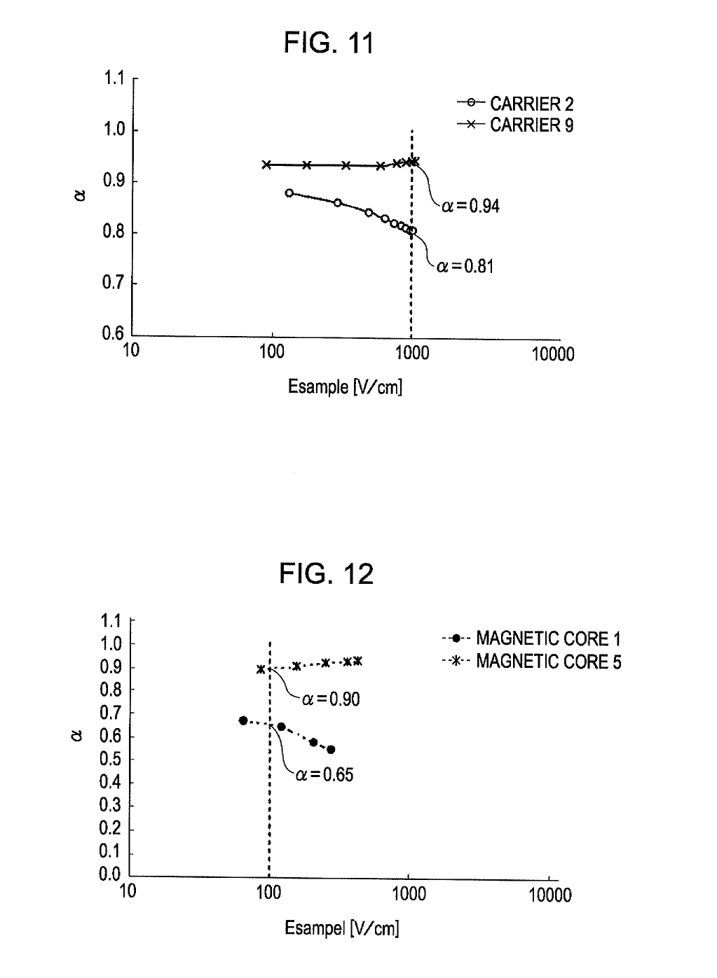

FIG. 11 shows the applied electric field (Esample) dependence of α of carriers 2 and 9.

FIG. 12 shows the applied electric field (Esample) dependence of α of magnetic cores 1 and 5.

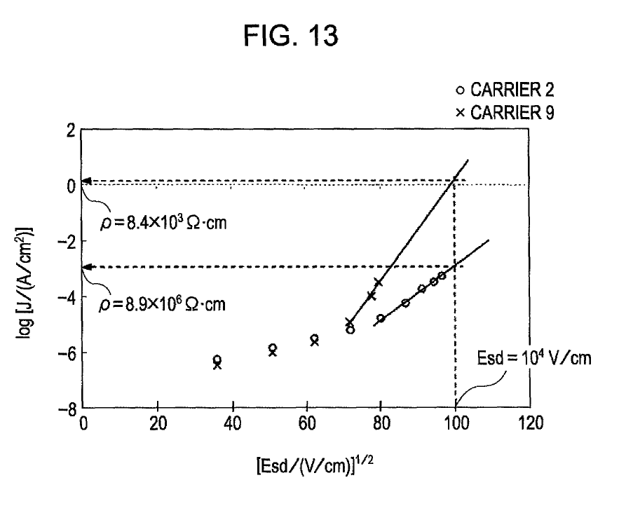

FIG. 13 shows the applied electric field (Esd) dependence of the current density J of carriers 2 and 9.

TABLE

| | | Electrical properties | | | Development properties | | |
|---|---|---|---|---|---|---|---|
| | | Carrier | | Core | | Graininess | Gradation |
| | | | Resistivity | α (Core | developability | Granularity | Effective |
| | Carrier No. | α (carrier) | ρ (Ω · cm) | particles) | Q/S (nC/cm²) | GS | gradation |
| Example 1 | Porous ferrite | 0.76 | 3.4 × 10⁶ | 0.65 | 16.2 (A) | 0.172 (B) | 0.90 (B) |
| | carrier 1 | | | | | | |
| Example 2 | Porous ferrite | 0.81 | 8.9 × 10⁶ | 0.65 | 15.5 (B) | 0.168 (A) | 0.93 (A) |
| | carrier 2 | | | | | | |
| Example 3 | Porous ferrite | 0.88 | 2.7 × 10⁷ | 0.65 | 14.9 (C) | 0.165 (A) | 0.91 (B) |
| | carrier 3 | | | | | | |
| Example 4 | Porous ferrite | 0.72 | 7.0 × 10⁵ | 0.70 | 16.5 (A) | 0.177 (B) | 0.89 (C) |
| | carrier 4 | | | | | | |
| Example 5 | Porous ferrite | 0.88 | 1.3 × 10⁸ | 0.73 | 14.6 (C) | 0.166 (A) | 0.93 (A) |
| | carrier 5 | | | | | | |
| Example 6 | Porous ferrite | 0.87 | 2.6 × 10⁷ | 0.75 | 14.9 (C) | 0.168 (A) | 0.92 (B) |
| | carrier 6 | | | | | | |
| Example 7 | Porous ferrite | 0.87 | 5.1 × 10⁷ | 0.79 | 14.1 (C) | 0.171 (B) | 0.91 (B) |
| | carrier 11 | | | | | | |
| Example 8 | Porous ferrite | 0.70 | 2.1 × 10⁶ | 0.56 | 15.8 (B) | 0.178 (B) | 0.92 (B) |
| | carrier 12 | | | | | | |
| Comparative | Porous ferrite | 0.93 | 1.1 × 10⁸ | 0.65 | 13.9 (D) | 0.172 (B) | 0.90 (B) |
| Example 1 | carrier 7 | | | | | | |
| Comparative | Porous ferrite | 0.96 | 2.2 × 10⁸ | 0.65 | 13.5 (D) | 0.165 (A) | 0.91 (B) |
| Example 2 | carrier 8 | | | | | | |
| Comparative | Ferrite carrier 9 | 0.94 | 8.4 × 10³ | 0.90 | 15.7 (B) | 0.193 (D) | 0.84 (D) |
| Example 3 | | | | | | | |
| Comparative | Porous ferrite | 0.91 | 8.4 × 10⁶ | 0.82 | 13.8 (D) | 0.176 (B) | 0.87 (C) |
| Example 4 | carrier 10 | | | | | | |

As is clear from the results shown in the table, carriers 1 to 6, 11 and 12 can prevent development charge injection and provide images having low graininess and good gradation while ensuring high developability.

Carrier 7 contains the same low-α magnetic core particles 1 as carriers 1 to 3, but has a high coating resin content. Consequently, the resistivity ρ becomes higher than that of Carriers 1 to 3, and α of the carrier is increased.

Carrier 8 contains the same magnetic core particles 1 as carrier 2 and is coated with the same coating resin as carrier 2. However, Carrier 8 exhibits a higher α and a higher resistivity ρ than carrier 2 because the coating processes were different between carriers 2 and 8.

In order to investigate the cause of the above results, reflection electron images of the surfaces of carrier particles taken through a scanning electron microscope were observed. As a result, it was found that the percentage of core particles exposed at the carrier surfaces is extremely lower in carriers 7 and 8 than in carriers 1 to 3. Thus, it was found that the coating process employed for preparing carrier 8 can form more uniform coatings over the carrier surfaces than the coating process for carriers 1 to 3. In carriers 7 and 8, probably, the charge transfer between the carrier particles in an electric field is liable to be prevented, and thus the resistance is increased. In addition, the effect of the spread of time constant distribution inside the carrier may be lost by the increase of the resistance of the carrier, and a of the carrier may be increased.

Thus, since carriers 7 and 8 can prevent the degradation of image quality caused by development charge injection, but have large α, their developabilities are reduced and a sufficient image density cannot be achieved.

The volume of the pores in the ferrite core particles 5 contained in carrier 9 is extremely small unlike that in ferrite core particles 1 to 4. It is therefore supposed that the variation of the state of connections among ferrite crystal grains in the core particles is reduced to increase the α value of the core particles. Consequently, the α value of the carrier is larger than that of carriers 1 to 6 even though the amount of coating resin is substantially the same as that of carrier 1. Furthermore, although carrier 9 had a sufficient image density, development charge injection occurred to increase the graininess and reduce the gradation, because of low resistivity ρ.

Accordingly, it is important to give variations to the state of connections among ferrite crystal grains in each particle so as to broaden the time constant distribution, and important to control the α value of the carrier in the range of 0.70 to 0.90. Use of such a carrier can produce high-quality images having low graininess and good gradation while ensuring sufficient image density.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-325069 filed Dec. 22, 2008, which is hereby incorporated by reference herein in its entirety.

What is claimed is:

1. A carrier having an impedance Z having a frequency dependence, obtained by alternating current impedance measurement,
wherein when the frequency dependence is fitted by a fitting function expressed by formula (I), parameter α lies in a range of 0.70 to 0.90 in an electric field of 10³ V/cm:
$$Z ( ω ) = Re [ Z ( ω ) ] + i Im [ Z ( ω ) ] = Rs + \frac{R}{1 + {RT ( i ω )}^{α}} \qquad ( 1 )$$
wherein i represents an imaginary unit, ω represents an angular frequency for alternating current impedance measurement, Rs and R represent real number parameters with the dimension of resistance, α represents a dimensionless real number parameter of 0 to 1, and T represents a real number parameter and (RT)^{1/α} has the dimension of time.

2. The carrier according to claim 1, wherein the carrier in a magnetic brush state has a dynamic electric resistivity in a range of 1.0×10⁶ to 1.0×10⁸Ω·cm in an electric field of 10⁴ V/cm.

3. The carrier according to claim 1, wherein the carrier contains a porous ferrite core particle and a resin, and wherein when a section of the carrier is observed in a reflection electron image taken by scanning electron microscopy, the ferrite core particle occupies 50% to 90% of the entire section of the carrier.

4. The carrier according to claim 3, wherein the parameter α of the fitting function (1) lies in a range of 0.50 to 0.80 in an electric field of 10² V/cm.

5. A two-component developer comprising: a carrier as set forth in claim 1; and a toner.

6. A method comprising:
charging an electrostatic latent image bearing member with a charger;
exposing the charged electrostatic latent image bearing member to form an electrostatic latent image; and
developing the electrostatic latent image by forming a magnetic brush of the two-component developer as set forth in claim 5 on a developer bearing member and applying a developing bias between the electrostatic latent image bearing member and the developer bearing member with the magnetic brush in contact with the electrostatic latent image bearing member,
wherein the developing bias is produced by superimposing an alternating electric field on a direct electric field.

7. The method according to claim 6, wherein the alternating electric field has a peak-to-peak voltage in the range of 0.7 to 1.8 kV.
